(19) United States
(12) Patent Application Publication
(10) Pub. No.: US 2018/0015652 A1
(43) Pub. Date: Jan. 18, 2018

(54) INJECTION FLOW CONTROL APPARATUS AND METHOD

(71) Applicant: Synventive Molding Solutions, Inc., Peabody, MA (US)

(72) Inventor: Vito Galati, Rowley, MA (US)

(21) Appl. No.: 15/715,906

(22) Filed: Sep. 26, 2017

Related U.S. Application Data
(63) Continuation-in-part of application No. 15/442,173, filed on Feb. 24, 2017.
Application No. 15/442,173 is a continuation of application No. 14/708,533, filed on May 11, 2015, now Pat. No. 9,604,399.
Application No. 14/708,533 is a continuation of application No. PCT/US2013/071667, filed on Nov. 25, 2013.
Application No. PCT/US2013/071667 is a continuation-in-part of application No. 14/930,692, filed on Nov. 3, 2015.
Application No. 14/930,692 is a continuation of application No. 13/569,464, filed on Aug. 8, 2012, now Pat. No. 9,205,587.
Application No. 13/569,464 is a continuation-in-part of application No. 15/291,721, filed on Oct. 12, 2016.
Application No. 15/291,721 is a continuation of application No. 14/311,785, filed on Jun. 23, 2014, now Pat. No. 9,498,909.
Application No. 14/311,785 is a continuation-in-part of application No. 13/484,336, filed on May 31, 2012, now Pat. No. 9,011,736.
Application No. 13/484,336 is a continuation of application No. PCT/US2011/062099, filed on Nov. 23, 2011.
Application No. PCT/US2011/062099 is a continuation-in-part of application No. 15/286,917, filed on Oct. 6, 2016.
Application No. 15/286,917 is a continuation of application No. 14/325,443, filed on Jul. 8, 2014, now Pat. No. 9,492,960.
Application No. 14/325,443 is a continuation-in-part of application No. 14/567,308, filed on Dec. 11, 2014, now Pat. No. 9,623,598.
Application No. 14/567,308 is a division of application No. 13/484,336, filed on May 31, 2012, now Pat. No. 9,011,736.
Application No. 13/484,336 is a continuation of application No. PCT/US2011/062099, filed on Nov. 23, 2011.
Application No. PCT/US2011/062099 is a continuation-in-part of application No. 15/215,774, filed on Jul. 21, 2016.
Application No. 15/215,774 is a continuation of application No. 14/834,586, filed on Aug. 25, 2015, now Pat. No. 9,427,905.
(60) Provisional application No. 61/475,340, filed on Apr. 14, 2011.
(60) Provisional application No. 61/416,583, filed on Nov. 23, 2010.

(51) Int. Cl. B29C 45/28; B29C 45/27; B29C 45/76; B29C 45/77; B29C 45/17

(52) U.S. Cl. CPC B29C 45/281; B29C 45/2806; B29C 45/76; B29C 45/77; B29C 45/2703; B29C 2945/76381; B29C 2945/7628; B29C 2945/76277; B29C 2945/76083; B29C 2945/76076; B29C 2945/76006; B29C 2045/2872; B29C 2045/2865; B29C 2045/2712; B29C 2045/1792; B29C 2945/76545; B29C 2945/76598; B29C 2945/76755; B29C 2945/76933; B29C 2945/76859

(57) ABSTRACT

An actuator assembly comprising a piston interconnected to a valve pin, the piston being driven by drive fluid controlled by a restriction valve,
a pressure sensor adapted to sense pressure of the drive fluid disposed within an upstream drive chamber or within an upstream drive fluid channel connecting the drive chamber and the restriction valve,
the pressure sensor sending and a controller receiving a signal indicative of the sensed pressure, the controller operating to execute a display of a visually recognizable format corresponding to the sensed pressure or an algorithm to control movement of the piston.

### RELATED APPLICATIONS

This application is a continuation-in-part of and claims the benefit of priority to U.S. application Ser. No. 15/442,173 filed Feb. 24, 2017 which is in turn a continuation of U.S. application Ser. No. 14/708,533 (7127US1) filed May 11, 2015 which is a continuation of international application PCT/US2013/071667 filed Nov. 25, 2013 the disclosures of both which are incorporated herein by reference in their entirety as if fully set forth herein.

This application is also a continuation in part of and claims the benefit of priority to U.S. application Ser. No. 14/930,692 filed Nov. 3, 2015 (7117US1) which is a continuation of U.S. application Ser. No. 13/569,464 filed Aug. 8, 2012 (7117U50), the disclosures of all of the foregoing of which are incorporated by reference in their entirety as if fully set forth herein.

This application is also a continuation in part of and claims the benefit of priority to U.S. application Ser. No. 15/291,721 filed Oct. 12, 2016 (7134US2) which is a continuation of U.S. application Ser. No. 14/311,785 filed Jun. 23, 2014 which is a continuation-in-part of U.S. application Ser. No. 13/484,336 filed May 31, 2012 which is a continuation of PCT/US2011/062099 filed Nov. 23, 2011, the disclosures of all of the foregoing of which are incorporated by reference in their entirety as if fully set forth herein.

This application is also a continuation in part of and claims the benefit of priority to U.S. application Ser. No. 15/286,917 filed Oct. 6, 2016 (7135US2) which is a continuation of U.S. application Ser. No. 14/325,443 filed Jul. 8, 2014 the disclosures of all of the foregoing of which are incorporated by reference in their entirety as if fully set forth herein.

This application is also a continuation in part of and claims the benefit of priority to U.S. application Ser. No. 14/567,308 filed Dec. 11, 2014 (7100U54) which is a divisional of U.S. application Ser. No. 13/484,336 filed May 31, 2012 which is a continuation of and claims the benefit of priority of PCT/US11/62099 filed Nov. 23, 2011 which in turn claims the benefit of priority to U.S. Provisional Application Ser. No. 61/475,340 filed Apr. 14, 2011 and to U.S. Provisional Application Ser. No. 61/416,583 filed Nov. 23, 2010, the disclosures of all of the foregoing of which are incorporated by reference herein in their entirety as if fully set forth herein.

This application is also a continuation in part of and claims the benefit of priority to U.S. application Ser. No. 15/215,774 filed Jul. 21, 2016 (7118US2) which is a continuation of U.S. application Ser. No. 14/834,586 filed Aug. 25, 2015, the disclosures of all of the foregoing of which are incorporated by reference herein in their entirety as if fully set forth herein.

The disclosures of all of the following are incorporated by reference in their entirety as if fully set forth herein: International Application Publication No. WO2012/074879, U.S. Patent Application Publication No. 2012/0248644, International Application Publication No. 2012/087491, U.S. Patent Application Publication No. 2012/0248652, U.S. Pat. No. 5,894,025, U.S. Pat. No. 6,062,840, U.S. Pat. No. 6,294,122, U.S. Pat. No. 6,309,208, U.S. Pat. No. 6,287,107, U.S. Pat. No. 6,343,921, U.S. Pat. No. 6,343,922, U.S. Pat. No. 6,254,377, U.S. Pat. No. 6,261,075, U.S. Pat. No. 6,361,300 (7006), U.S. Pat. No. 6,419,870, U.S. Pat. No. 6,464,909 (7031), U.S. Pat. No. 6,599,116, U.S. Pat. No. 7,234,929 (7075US1), U.S. Pat. No. 7,419,625 (7075US2), U.S. Pat. No. 7,569,169 (7075US3), U.S. patent application Ser. No. 10/214,118, filed Aug. 8, 2002 (7006), U.S. Pat. No. 7,029,268 (7077US1), U.S. Pat. No. 7,270,537 (7077US2), U.S. Pat. No. 7,597,828 (7077US3), U.S. patent application Ser. No. 09/699,856 filed Oct. 30, 2000 (7056), U.S. patent application Ser. No. 10/269,927 filed Oct. 11, 2002 (7031), U.S. application Ser. No. 09/503,832 filed Feb. 15, 2000 (7053), U.S. application Ser. No. 09/656,846 filed Sep. 7, 2000 (7060), U.S. application Ser. No. 10/006,504 filed Dec. 3, 2001, (7068) and U.S. application Ser. No. 10/101,278 filed Mar., 19, 2002 (7070), U.S. Pat. No. 8,297,836 (7087), U.S. Pat. No. 8,328,549 (7096) and international applications PCT/US2011/062099 (7100) and PCT/US2011/062096 (7100), PCT/US2014/043612, PCT/US2013/075064 filed Dec. 13, 2013, PCT/US2014/019210 filed Feb. 28, 2014, PCT/US2014/031000 and PCT/US2014/032658.

### BACKGROUND OF THE INVENTION

Injection molding systems have been developed having flow control mechanisms that control the movement of a valve pin over the course of an injection cycle based on measuring pressure of injection fluid directly with a pressure sensor disposed with an injection fluid flow channel or the cavity of a mold.

### SUMMARY OF THE INVENTION

In accordance with the invention there is provided in an apparatus (10) for controlling flow of fluid injection material (18, 100a, 100b) from an injection molding machine to a mold cavity (30), wherein the apparatus comprises: a manifold (40) receiving the injected fluid mold material, the manifold having one or more fluid delivery channels (42, 44, 46) that delivers the injected fluid material (100a, 100b) through a gate (32, 34, 36) to the mold cavity (30);
a pressure sensing assembly comprising:
an actuator (20a, 940, 941, 942) comprising a piston (40p) interconnected to a valve pin (1040, 1041, 1042) drivable along a drive path that extends between a gate closed position (40gc) where a distal end (1155) of the valve pin (1040, 1041, 1042) (1041) stops flow through (GC) the gate and an upstream open position where the distal end (1155) of the valve pin is withdrawn upstream to enable injection fluid material (100a, 100b) to flow through the gate (32, 34, 36),
the piston (40p) being housed within a piston housing (20h) in an arrangement that forms an upstream drive chamber (30u) and a downstream drive chamber (30d), the upstream drive chamber having a drive fluid port (50, 52) fluid sealably interconnected via an upstream drive fluid channel (704) to a restriction valve (600), the piston (40p) being drivable upstream and downstream by drive fluid (14) pumped into and out of the upstream drive chamber (30u) through the drive fluid port (50, 52), drive fluid channel (704) and restriction valve (600),
a pressure sensor (603e, 603ec) adapted to sense pressure of the drive fluid (14) disposed within the upstream drive chamber (30u) or within the upstream drive fluid channel (704),
a controller (16) that includes a program that instructs the restriction valve (600) to close for a first portion of an injection cycle to prevent flow of the drive fluid (14) such that the piston (40p) is held or stopped in a first position where drive fluid (DF) resides and remains within the upstream drive chamber (30u) or within the upstream drive fluid channel (704) without flow through the restriction valve (600) during the first portion of the injection cycle,
the pressure sensor (603e, 603ec) sensing pressure of the drive fluid (DF) resident and remaining within either the upstream drive chamber (30u) or the upstream drive fluid channel (704) during the first portion of the injection cycle,
the pressure sensor (603e, 603ec) sending and the controller (16) receiving a signal indicative of the sensed pressure, wherein the controller (16) operates to execute a display (1300) of a visually recognizable format corresponding to the sensed pressure or uses the received signal in an algorithm to control movement of the piston (40p).

The controller (16) preferably includes instructions that operate to display a visually recognizable format of the sensed pressure as either sensed pressure of the drive fluid (DF) or pressure of the injection fluid (100a, 100b) that correlates to the sensed pressure (DF) of the drive fluid.

The controller (16) can includes instructions that instruct the piston (40p) to travel to a selected maximum upstream position during the course of the injection cycle that leaves a space or volume (30s) within which drive fluid (DF) resides during the first portion of the injection cycle.

The maximum upstream position of the piston (40p) is typically selected such that an upstream end surface (40e) of the piston (40p) is spaced an axial distance of between 0.1 and 2.0 mm from an opposing undersurface (20uws) of an upstream wall of the upstream drive chamber (30u).

The maximum upstream position of the piston (40p) can be selected such that an upstream end surface (40e) of the piston (40p) is spaced an axial distance of between 0.25 and 1.0 mm from an opposing undersurface (20uws) of an upstream wall of the upstream drive chamber (30u).

An upstream surface (40e) of the piston (40p) typically remains spaced at least a selected axial distance greater than 0.1 mm away from an undersurface (20uws) of the housing (40h) or upstream drive chamber (30U) during the entire course of the injection cycle.

The pressure sensor assembly can include a source of drive fluid (14) that is drivable into and out of the upper drive chamber (30u) through the restriction valve (600) and upstream drive fluid channel (704), the restriction valve (600) being controllably openable by the controller (16) to a selected degree to enable flow of drive fluid (DF, FEX) into and out of the upstream drive chamber (30u) at a selectable rate of flow to control rate of travel of the piston (40p), the restriction valve (600) being controllably closable to controllably stop flow of drive fluid (DF) into and out of the upstream drive chamber (30u) and to stop movement of the piston (40p).

The controller (16) can includes instructions that instruct the piston (40p) to travel, subsequent to the first portion of the injection cycle, to a second position for a second portion of the injection cycle where a distal end (1155) of the valve pin (1041) is positioned relative to the gate such that flow of injection fluid (100a, 100b) is selectively controlled.

The instructions of the controller (16) can operate to drive the piston (40p) to the second position in response to receipt of a first trigger signal from the pressure sensor (603e, 603ec) that is indicative of a first selected target pressure.

The controller (16) can include instructions that instruct the piston (40p) to travel, subsequent to the second portion of the injection cycle, to a third position for a third portion of the injection cycle where a distal end (1155) of the valve pin (1041) is positioned relative to the gate such that flow of injection fluid (100a, 100b) is selectively controlled.

The instructions of the controller (16) can operate to drive the piston (40p) to the third position in response to receipt of a second trigger signal from the pressure sensor (603e, 603ec) that is indicative of a second selected target pressure.

The first position can be a position where a distal end (1155) of the valve pin (1041) is positioned relative to the gate (32, 34, 36) such that flow of injection fluid (100a, 100b) is not significantly restricted and injection fluid (100a, 100b) flows at a maximum speed or a relatively high speed or velocity or pressure at and through the gate and the second position is a position wherein the distal end (1155) of the valve pin (1041) is disposed axially intermediate a gate closed (40gc) and a fully gate open position such that the end (1155) of the valve pin (1041) restricts or reduces rate or velocity of flow or pressure of the injection fluid (100a, 100b) flowing through or exerted at the gate to a selected reduced velocity or pressure that is less than a maximum rate of flow or pressure.

The second position can be a position where a distal end (1155) of the valve pin (1041) is positioned relative to the gate (32, 34, 36) such that flow of injection fluid (100a, 100b) is (a) not significantly restricted and injection fluid (100a, 100b) flows at a relatively high speed or velocity or pressure at and through the gate or (b) such that the distal end (1155) of the valve pin (1041) is disposed axially intermediate a gate closed (40gc) and a fully gate open position such that the end (1155) of the valve pin (1041) restricts or reduces rate or velocity of flow or pressure of the injection fluid (100a, 100b) flowing through or exerted at the gate to a selected reduced velocity or pressure that is less than a maximum velocity or pressure.

The controller (16) can include instructions that instruct the actuator (40p) to drive the valve pin (1041) upstream beginning from the gate closed position to the first position for the first portion of the injection cycle and subsequently to one or more different subsequent positions for one or more different subsequent portions of the injection cycle in response to receipt by the controller (16)) of one or more trigger signals from the pressure sensor (603ec, 603e) corresponding to one or more selected sensed target pressures.

One or more of the second and third positions can be positions where a distal end (1155) of the valve pin (1041) is positioned relative to the gate such that flow of injection fluid (100a, 100b) is not significantly restricted and injection fluid (100a, 100b) flows at a relatively high speed or velocity or pressure at and through the gate or such that the distal end (1155) of the valve pin (1041) is disposed axially intermediate a gate closed and a fully gate open position such that the end (1155) of the valve pin (1041) restricts or reduces rate or velocity of flow or pressure of the injection fluid (100a, 100b) flowing through or exerted at the gate to a selected reduced velocity or pressure that is less than a maximum rate of flow or pressure.

In another aspect of the invention there is provided a method of measuring pressure of an injection fluid material (100a, 100b) injected into an apparatus (10) for controlling rate of flow of the injection fluid material (18, 100a, 100b) from an injection molding machine to a mold cavity (30), wherein the apparatus comprises: a manifold (40) receiving the injected fluid material, the manifold having one or more fluid delivery channels (42, 44, 46) that delivers the injected fluid material (100a, 100b) through a gate (32, 34, 36) to the mold cavity (30), an actuator (20a, 940, 941, 942) comprising a piston (40p) interconnected to a valve pin (1040, 1041, 1042) drivable along a drive path that extends between a gate closed position where a distal end (1155) of the valve pin (1040, 1041, 1042) (1041) obstructs (GC) the gate and an upstream open position where the distal end (1155) of the valve pin is withdrawn upstream to enable injection fluid material (100a, 100b) to flow through the gate (32, 34, 36), wherein the piston (40p) is housed within a piston housing (20h) in an arrangement that forms an upstream drive chamber (30u) and a downstream drive chamber (30d), the upstream drive chamber having a drive fluid port (50, 52) fluid sealably interconnected via an upstream drive fluid channel (704) to a restriction valve (600), the piston (40p) being drivable upstream and downstream by drive fluid (14) pumped into and out of the upstream drive chamber (30u) through the drive fluid port (50, 52), drive fluid channel (704) and restriction valve (600),
the method being characterized in that:
a pressure sensor (603e, 603ec) is adapted to sense pressure of the drive fluid (14) disposed within the upstream drive chamber (30u) or within the upstream drive fluid channel (704),
the restriction valve (600) is closed for a first portion of an injection cycle to prevent flow of the drive fluid (14) such that the piston (40p) is held or stopped in a first fully or partially open position where drive fluid (DF) resides and remains within the upstream drive chamber (30u) or within the upstream drive fluid channel (704) without flow through the restriction valve (600) during the first portion of the injection cycle,
pressure of the drive fluid (DF) resident and remaining within either the upstream drive chamber (30u) or the upstream drive fluid channel (704) is sensed via the pressure sensor (603e, 603ec) during the first portion of the injection cycle,
the sensed pressure of the drive fluid (DF) is either displayed on a display (1300) in a visually recognizable format (1310) corresponding to the sensed pressure or is used as a variable in an algorithm to control movement of the piston (40p).

In another aspect of the invention there is provided a method of measuring pressure of an injection fluid material (100a, 100b) comprising operating a pressure sensing assembly as described above.

In another aspect of the invention there is provided an apparatus (10) for controlling the rate of flow of fluid injection material (18, 100a, 100b) from an injection molding machine to a mold cavity (30), the apparatus comprising:
a manifold (40) receiving the injected fluid mold material, the manifold having one or more fluid delivery channels (42, 44, 46) that delivers the injected fluid material (100a, 100b) through a gate (32, 34, 36) to the mold cavity (30);
an actuator (20a, 940, 941, 942) comprising a piston (40p) interconnected to a valve pin (1040, 1041, 1042) drivable along a drive path that extends between a gate closed position where a distal end (1155) of the valve pin (1040, 1041, 1042) (1041) obstructs (GC) the gate and an upstream open position where the distal end (1155) of the valve pin is withdrawn upstream to enable injection fluid material (100a, 100b) to flow through the gate (32, 34, 36),
the piston (40p) being housed within a piston housing (20h) in an arrangement that forms an upstream drive chamber (30u) and a downstream drive chamber (30d), the upstream drive chamber having a drive fluid port (50, 52) fluid sealably interconnected via an upstream drive fluid channel (704) to a restriction valve (600), the piston (40p) being drivable upstream and downstream by drive fluid (14) pumped into and out of the upstream drive chamber (30u) through the drive fluid port (50, 52), drive fluid channel (704) and restriction valve (600),
a pressure sensor (603e, 603ec) adapted to sense pressure of the drive fluid (14) disposed within the upstream drive chamber (30u) or within the upstream drive fluid channel (704),
a controller (16) that includes a program that instructs the restriction valve (600) to close for a first portion of an injection cycle to prevent flow of the drive fluid (14) such that the piston (40p) is held or stopped in a first fully or partially open position where drive fluid (DF) resides and remains within the upstream drive chamber (30u) or within the upstream drive fluid channel (704) without flow through the restriction valve (600) during the first portion of the injection cycle,
the pressure sensor (603e, 603ec) sensing pressure of the drive fluid (DF) resident and remaining within either the upstream drive chamber (30u) or the upstream drive fluid channel (704) during the first portion of the injection cycle.

In such an apparatus the controller (16) preferably includes instructions that operate to execute a display (1300) of a visually recognizable format corresponding to the sensed pressure or uses the received signal in an algorithm to control movement of the piston (40p).

The controller (16) preferably includes instructions that operate to display a visually recognizable format (310) of the sensed pressure as either sensed pressure of the drive fluid (DF) or pressure of the injection fluid (100a, 100b) that correlates to the sensed pressure (DF) of the drive fluid.

The controller (16) can include instructions that instruct the piston (40p) to travel to a selected maximum upstream position during the course of the injection cycle that leaves a space or volume (30s) within which drive fluid (DF) resides during the first portion of the injection cycle.

The maximum upstream position of the piston (40p) is typically selected such that an upstream end surface (40e) of the piston (40p) is spaced an axial distance of between 0.1 and 2.0 mm from an opposing undersurface (20uws) of an upstream wall of the upstream drive chamber (30u).

The maximum upstream position of the piston (40p) is typically selected such that an upstream end surface (40e) of the piston (40p) is spaced an axial distance of between 0.25 and 1.0 mm from an opposing undersurface (20uws) of an upstream wall of the upstream drive chamber (30u).

An upstream surface (40e) of the piston (40p) preferably remains spaced at least a selected axial distance of 0.1 mm or greater away from an undersurface (20uws) of the housing (40h) or upstream drive chamber (30U) during the entire course of the injection cycle.

The assembly typically includes a source of drive fluid (14) that is drivable into and out of the upper drive chamber (30u) through the restriction valve (600) and upstream drive fluid channel (704), the restriction valve (600) being controllably openable by the controller (16) to a selected degree to enable flow of drive fluid (DF, FEX) into and out of the upstream drive chamber (30u) at a selectable rate of flow to control rate of travel of the piston (40p), the restriction valve (600) being controllably closable to controllably stop flow of drive fluid (DF) into and out of the upstream drive chamber (30u) and to stop movement of the piston (40p).

The controller (16) can include instructions that instruct the piston (40p) to travel, subsequent to the first portion of the injection cycle, to a second position for a second portion of the injection cycle where a distal end (1155) of the valve pin (1041) is positioned relative to the gate such that flow of injection fluid (100a, 100b) is selectively controlled.

The instructions of the controller (16) preferably operate to drive the piston (40p) to the second position in response to receipt of a first trigger signal from the pressure sensor (603e, 603ec) that is indicative of a first selected target pressure.

The controller (16) can include instructions that instruct the piston (40p) to travel, subsequent to the second portion of the injection cycle, to a third position for a third portion of the injection cycle where a distal end (1155) of the valve pin (1041) is positioned relative to the gate such that flow of injection fluid (100a, 100b) is selectively controlled.

The instructions can operate to drive the piston (40p) to the third position in response to receipt of a second trigger signal from the pressure sensor (603e, 603ec) that is indicative of a second selected target pressure.

One or more of the second and third positions are preferably positions where a distal end (1155) of the valve pin (1041) is positioned relative to the gate such that flow of injection fluid (100a, 100b) is not significantly restricted and injection fluid (100a, 100b) flows at a relatively high speed or velocity or pressure at and through the gate or where the distal end (1155) of the valve pin (1041) is disposed axially intermediate a gate closed and a fully gate open position such that the end (1155) of the valve pin (1041) restricts or reduces rate or velocity of flow or pressure of the injection fluid (100a, 100b) flowing through or exerted at the gate to a selected reduced velocity or pressure that is less than a maximum rate of flow or pressure.

The controller (16) typically includes instructions that instruct the actuator (40p) to drive the valve pin (1041) upstream beginning from the gate closed position to the first position for the first portion of the injection cycle and subsequently to one or more of the second and third positions for the second and third portions of the injection cycle in response to receipt by the controller (16)) of the first and second trigger signals.

In another aspect of the invention there is provided a method of measuring pressure of an injection fluid material (100a, 100b) comprising operating an assembly as described above.

### BRIEF DESCRIPTION OF THE DRAWINGS

The above and further advantages of the invention may be better understood by referring to the following description in conjunction with the accompanying drawings in which:

FIG. 1 is a schematic of one embodiment of the invention showing a pair of sequential gates showing a first gate entering the center of a cavity having been opened and shown closed such that a first shot of fluid material has entered the cavity and traveled past the position of a second sequential gate, the second gate shown being open with its valve pin having traveled along an upstream restricted flow path RP allowing a second sequential shot of fluid material to flow into and merge with the first shot of material within the cavity;

FIGS. 1A-1E are schematic cross-sectional close-up views of the center and one of the lateral gates of the FIG. 1 apparatus showing various stages of the progress of injection;

FIG. 2A is a schematic of one embodiment of the invention showing generically a hydraulically actuated valve pin in which at least one port of the actuator is connected to a flow restrictor 600 so as to restrict the flow of hydraulic drive fluid and slow the opening of the valve pin by a selected lessening of pin opening velocity by use of a controller interconnected to the flow restrictor, the controller enabling the user to select a percentage of predetermined full open position velocity that the hydraulic drive supply to the actuator normally operates at full open velocity drive fluid pressure, the controller instructing the restrictor valve to operate at less than full open velocity up until the valve pin reaches a predetermined upstream position at which point a position sensor signals the controller and the controller instructs the restrictor valve to open to a full open full velocity degree of openness position;

FIG. 2AA is a schematic cross-sectional view of a hydraulic valve and restrictor configuration used in the system of FIG. 1 showing a metering restriction valve 600 disposed in the drive fluid flow line that interconnects the directional valve and the upper fluid chamber of the piston, and showing a pressure sensor connected to the controller and disposed in and sensing the pressure of metered hydraulic drive fluid as it exits the metering restrictor valve 600 and flow toward the directional valve during the withdrawal or upstream-cycle of the actuator 941;

FIG. 2B is a schematic of an alternative embodiment to the FIG. 2A system showing generically a hydraulically actuated valve and its interconnection to the hydraulic system and the control system for operating the restrictor valve 600 to cause the valve pin to withdraw at the beginning of a cycle at a predetermined reduced velocity for a predetermined amount of time subsequent to which the control system instructs the restrictor valve to open to a full open full velocity degree of openness position;

FIGS. 3A-3B show tapered end valve pin positions at various times and positions between a starting closed position as in FIG. 3A and various upstream opened positions, RP representing a selectable path length over which the velocity of withdrawal of the pin upstream from the gate closed position to an open position is reduced (via a controllable flow restrictor) relative to the velocity of upstream movement that the valve pin would normally have over the uncontrolled velocity path FOV when the hydraulic pressure is normally at full pressure and pin velocity is at its maximum;

FIGS. 4A-4B show a system having a valve pin that has a cylindrically configured tip end, the tips ends of the pins being positioned at various times and positions between a starting closed position as in FIG. 4A and various upstream opened positions, RP wherein RP represents a path of selectable length over which the velocity of withdrawal of the pin upstream from the gate closed position to an open position is reduced (via a controllable flow restrictor or electric actuator) relative to the velocity of upstream movement that the valve pin would normally have over the uncontrolled velocity path FOV when the hydraulic pressure of a hydraulic actuator is normally at full pressure and pin velocity is at its maximum;

FIGS. 5A-5D are a series of plots of pin velocity versus position each plot representing a different example of the opening of a gate lateral to a central gate via continuous upstream withdrawal of a valve pin at one rate or set of rates over an initial flow path RP and at another higher rate or set of rates of upstream withdrawal of the valve pin beginning at a pin position of FOP and beyond when the fluid material flow is typically at a maximum unrestricted rate of flow through the open gate without any restriction or obstruction from the tip end of the pin;

FIG. 5AA shows a plot corresponding to the velocity versus position plot of FIG. 5A of the metered pressure of drive fluid as sensed exiting metering restrictor valve 600 (in a configuration such as shown in FIG. 2A) versus upstream position of travel of the valve pin 1041 of actuator 941 beginning from a fully closed position at position zero where the;

FIG. 5AAA shows a plot also corresponding to the velocity versus position plot of FIG. 5A of the metered pressure of drive fluid as sensed exiting metering restrictor valve 600 (in a configuration such as shown in FIG. 2A) versus time of travel of the valve pin 1041 of actuator 941 beginning from a fully closed position at time zero;

FIG. 5BB shows a plot corresponding to the velocity versus position plot of FIG. 5B of the metered pressure of drive fluid as sensed exiting metering restrictor valve 600 (in a configuration such as shown in FIG. 2A) versus upstream position of travel of the valve pin 1041 of actuator 941 beginning from a fully closed position at position zero;

FIG. 5BBB shows a plot also corresponding to the velocity versus position plot of FIG. 5B of the metered pressure of drive fluid as sensed exiting metering restrictor valve 600 (in a configuration such as shown in FIG. 2A) versus time of travel of the valve pin 1041 of actuator 941 beginning from a fully closed position at time zero;

FIGS. 6A-6B show various embodiments of position sensors that can be used in a variety of FIG. 2A embodiments of the invention, the sensors shown in these figures being mounted so as to measure the position of the piston component of the actuator which is indicative of the position of the valve pin relative to the gate;

FIGS. 6C-6D show embodiments using limit switches that detect and signal specific positions of the actuator that can be used in a variety of FIG. 2A embodiments of the invention to determine velocity, position and switchover to higher openness of valve restrictor and/or upstream velocity of travel of the actuator and valve pin.

FIG. 6E is a schematic sectional view of a fluid driven actuator (hydraulic or pneumatic) showing the piston 40 of the actuator in its fully downstream position and the maximum upstream position MUP of the piston being such that the top upstream surface 40e of the piston 40 is spaced a minimum distance X from the inner upstream surface 20uws of the upstream wall 20uw of the actuator housing 20h.

FIGS. 7A-7D show various examples of downstream velocity protocols for driving a valve pin from a maximum upstream position to a gate closed position.

FIGS. 7E-7F show examples of downstream and upstream drive pin position protocols. FIG. 7E shows a protocol for driving a pin beginning from a maximum upstream position at a full velocity downstream to a partially gate open position where the tip end of the pin is disposed at about 4 mm from the gate resulting in reduced injection fluid flow and finally driven downstream from the 4 mm position at a reduced velocity to the gate closed position. In the FIG. 7E embodiment the tip end of the pin is held or maintained in the partially gate open 4 mm position for a selected period of time from about 0.15 and about 0.26 seconds. FIG. 7F shows a protocol for driving a pin from gate closed downstream upstream at a reduced velocity to a partially gate open position where the tip end of the pin is disposed at about 2.5 mm from the gate resulting in reduced injection fluid flow through the gate and finally driven upstream to a maximum upstream position at either a reduced velocity (shown in solid line) or at full velocity (shown in dashed line).

FIGS. 8A-8D are a series of graphs representing actual pressure (versus target pressure) measured in four injection nozzles coupled to a manifold, such as in the apparatus of FIG. 6; and

FIG. 9 shows an interactive screen display of a user interface, such as that shown in FIG. 1, which screen is used to display, create, edit and store sensed pressures or target profiles or the like.

### DETAILED DESCRIPTION

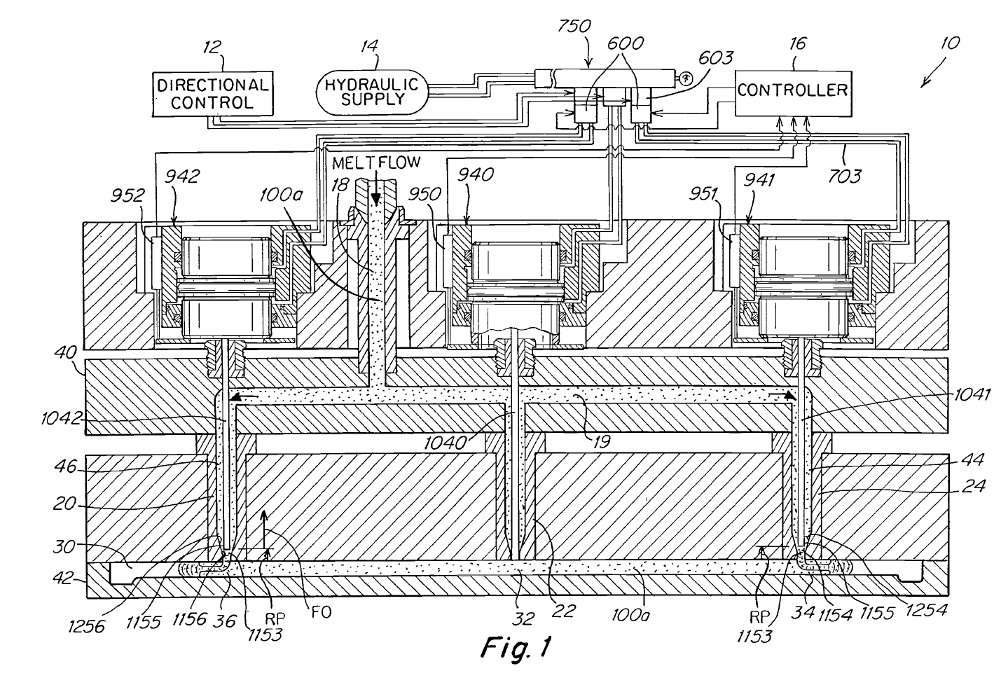

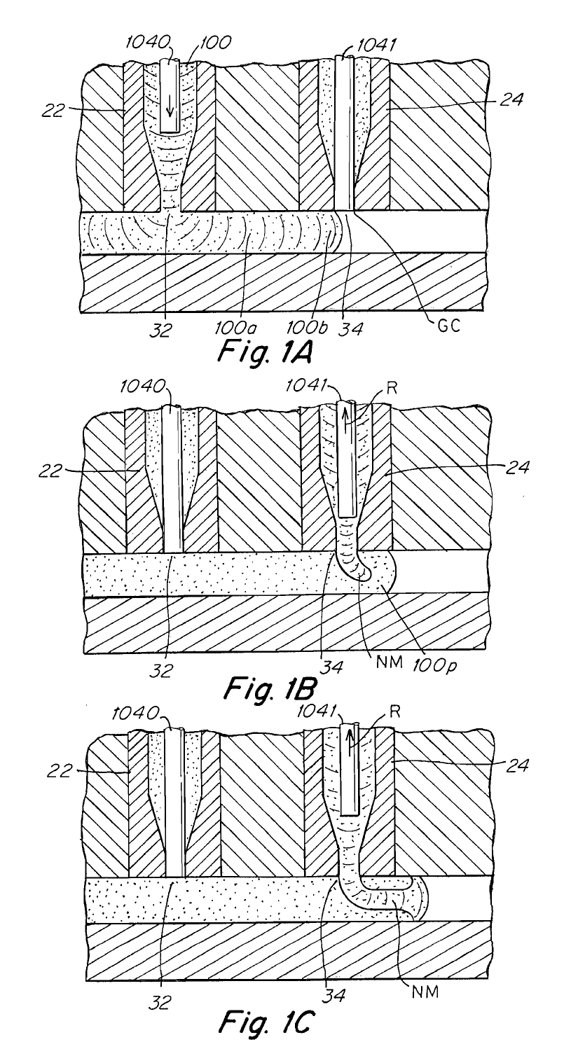

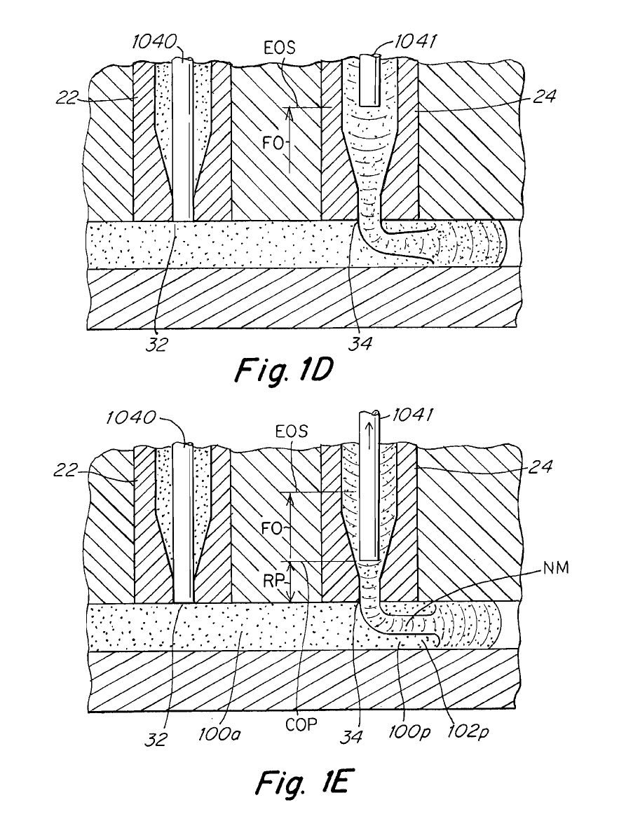

FIG. 1 shows a system 10 with a central nozzle 22 feeding molten material 100a, 100b from an injection molding machine through a main inlet 18 to a distribution channel 19 of a manifold 40. The distribution channel 19 commonly feeds three separate nozzles 20, 22, 24 which all commonly feed into a common cavity 30 of a mold 42. One of the nozzles 22 is controlled by actuator 940 and arranged so as to feed into cavity 30 at an entrance point or gate that is disposed at about the center 32 of the cavity. As shown, a pair of lateral nozzles 20, 24 feed into the cavity 30 at gate locations that are distal 34, 36 to the center gate feed position 32.

As shown in FIGS. 1, 1A the injection cycle is a cascade process where injection is effected in a sequence from the center nozzle 22 first and at a later predetermined time from the lateral nozzles 20, 24. As shown in FIG. 1A the injection cycle is started by first opening the pin 1040 of the center nozzle 22 and allowing the fluid material 100 (typically polymer or plastic material) to flow up to a position the cavity just before 100b the distally disposed entrance into the cavity 34, 36 of the gates of the lateral nozzles 24, 20 as shown in FIG. 1A. After an injection cycle is begun, the gate of the center injection nozzle 22 and pin 1040 is typically left open only for so long as to allow the fluid material 100b to travel to a position just past 100p the positions 34, 36. Once the fluid material has travelled just past 100p the lateral gate positions 34, 36, the center gate 32 of the center nozzle 22 is typically closed by pin 1040 as shown in FIGS. 1B, 1C, 1D and 1E. The lateral gates 34, 36 are then opened by upstream withdrawal of lateral nozzle pins 1041, 1042 as shown in FIGS. 1B-1E. As described below, the rate of upstream withdrawal or travel velocity of lateral pins 1041, 1042 is controlled as described below.

In alternative embodiments, the center gate 32 and associated actuator 940 and valve pin 1040 can remain open at, during and subsequent to the times that the lateral gates 34, 36 are opened such that fluid material flows into cavity 30 through both the center gate 32 and one or both of the lateral gates 34, 36 simultaneously.

When the lateral gates 34, 36 are opened and fluid material NM is allowed to first enter the mold cavity into the stream 102p that has been injected from center nozzle 22 past gates 34, 36, the two streams NM and 102p mix with each other. If the velocity of the fluid material NM is too high, such as often occurs when the flow velocity of injection fluid material through gates 34, 36 is at maximum, a visible line or defect in the mixing of the two streams 102p and NM will appear in the final cooled molded product at the areas where gates 34, 36 inject into the mold cavity. By injecting NM at a reduced flow rate for a relatively short period of time at the beginning when the gate 34, 36 is first opened and following the time when NM first enters the flow stream 102p, the appearance of a visible line or defect in the final molded product can be reduced or eliminated.

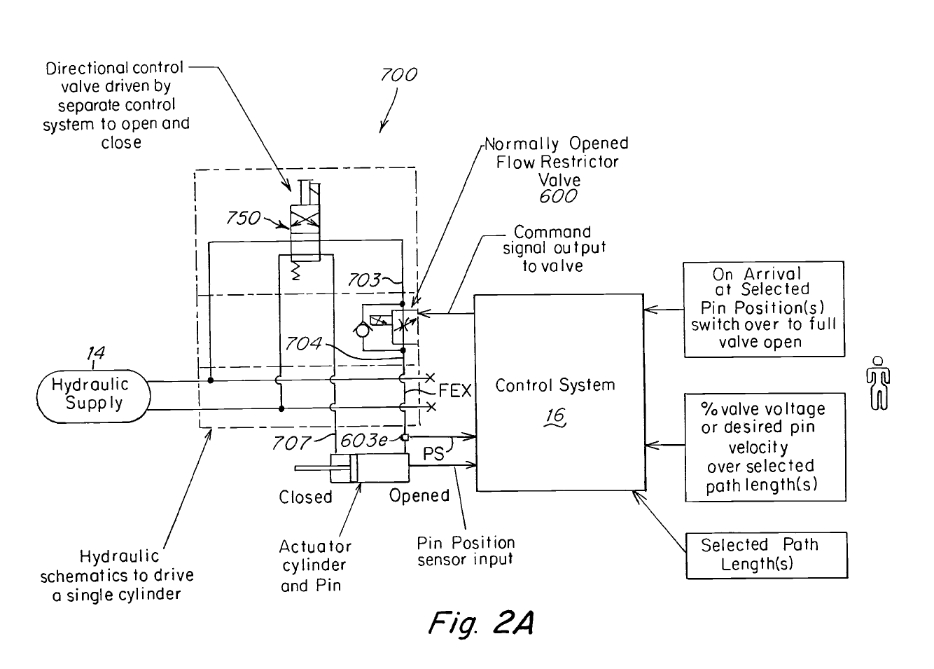

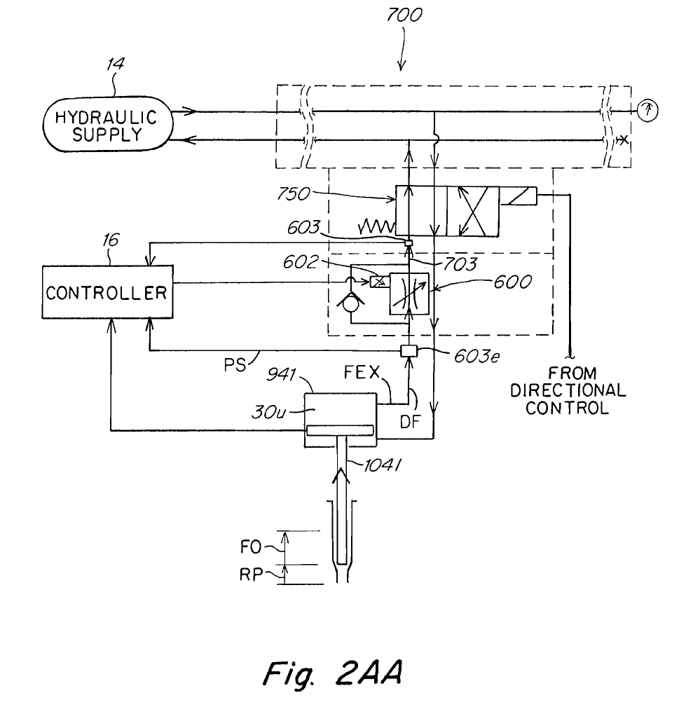

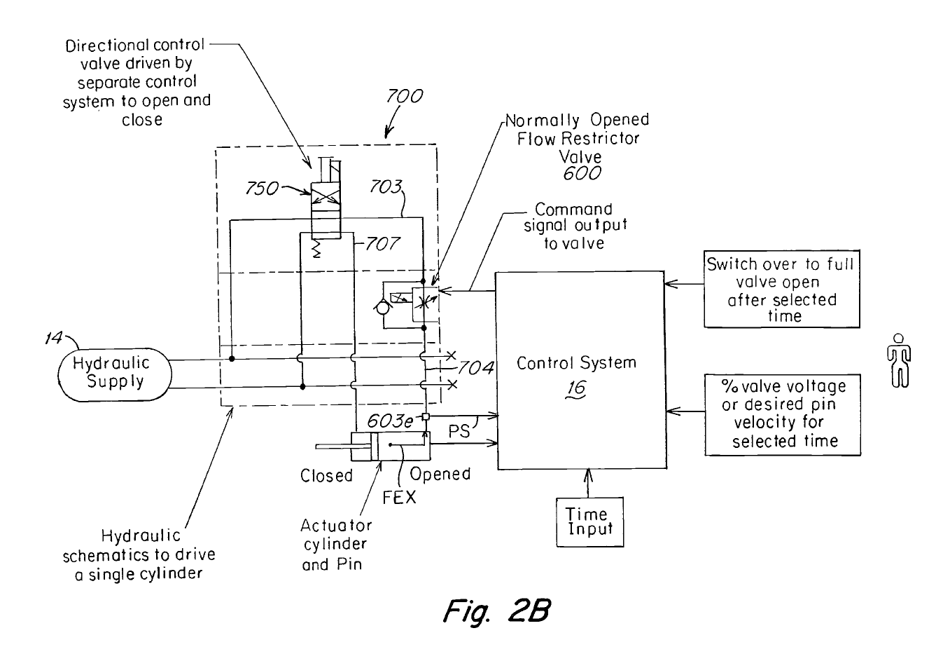

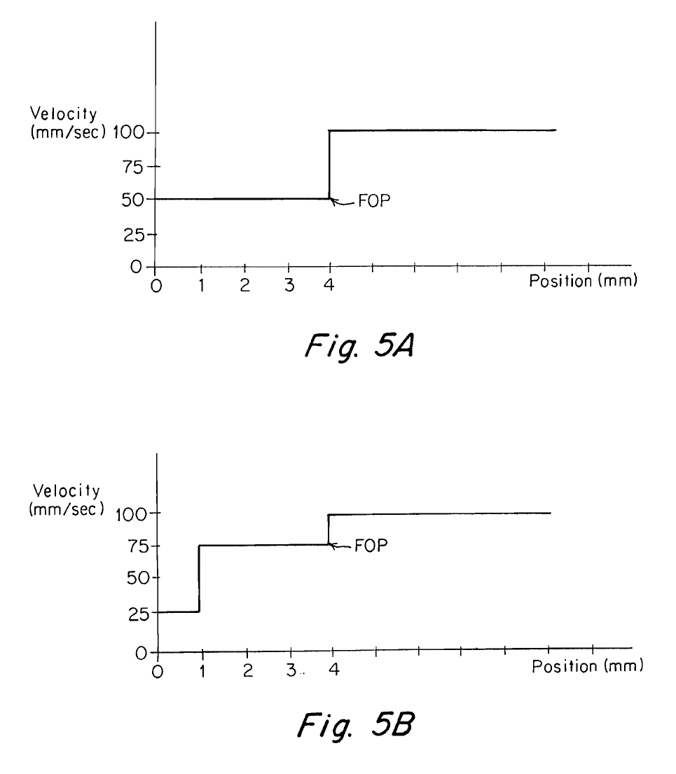

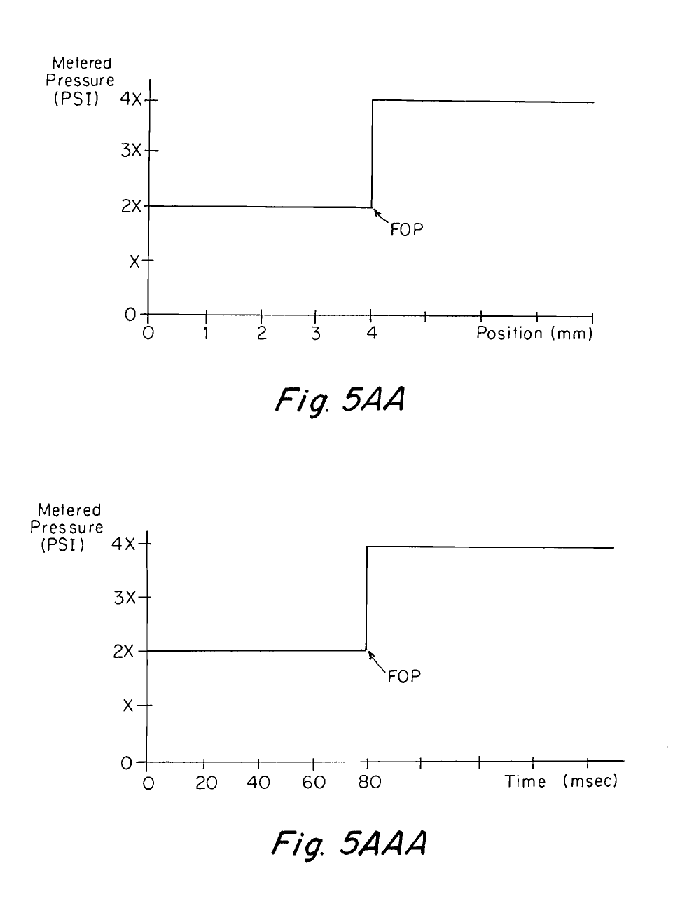

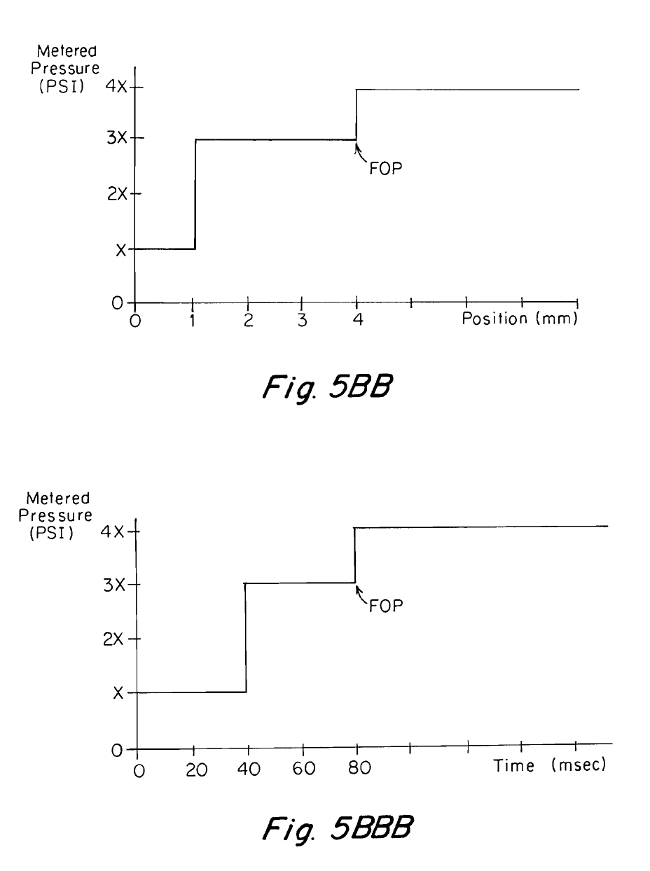

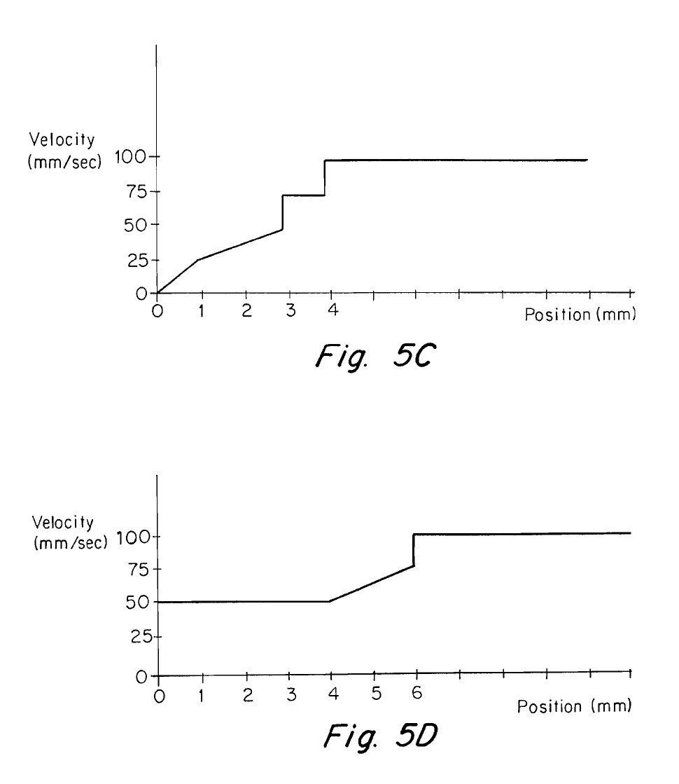

The rate or velocity of upstream withdrawal of pins 1041, 1042 starting from the closed position is controlled via controller 16, FIGS. 1, 2 which controls the rate and direction of flow of hydraulic fluid from the drive system 700 to the actuators 940, 941, 942. As discussed in detail below, a predetermined profile of metered drive fluid pressure versus position of the valve pin or actuator piston (examples of which are shown in FIGS. 5AA, 5BB) or metered drive fluid pressure versus elapsed time (examples of which are shown in FIGS. 5AAA, 5BBB) is input into the controller as the basis for controlling withdrawal of the valve pin(s) 1041 et al. at a reduced velocity relative to one or more selected higher velocities of withdrawal. The higher velocity is typically selected to be the highest velocity at which the system is capable of driving the actuators. The controller 16 receives a signal in real time from a pressure sensor 603 (or 605, 607) disposed in the drive fluid line communicating with the exit of the metering valve 600, the signal being indicative of the reduced drive fluid pressure in line 703 (or 705, 707). The controller 16 instructs the valve 600 to move to a degree of openness that causes the fluid pressure in the line to match the pressure of the predetermined profile at any given point in time or pin position along the pressure versus time profile (e.g. FIG. 5AAA or 5BBB) or pressure versus position profile (FIG. 5AA or 5BB. The pressure in the exit line of the metering valve 600 is proportional and corresponds to the velocity of withdrawal movement of the actuator 941 (940, 942) and associated valve pin 1041 (1040, 1042).

A “controller,” as used herein, refers to electrical and electronic control apparati that comprise a single box or multiple boxes (typically interconnected and communicating with each other) that contain(s) all of the separate electronic processing, memory and electrical signal generating components that are necessary or desirable for carrying out and constructing the methods, functions and apparatuses described herein. Such electronic and electrical components include programs, microprocessors, computers, PID controllers, voltage regulators, current regulators, circuit boards, motors, batteries and instructions for controlling any variable element discussed herein such as length of time, degree of electrical signal output and the like. For example a component of a controller, as that term is used herein, includes programs, controllers and the like that perform functions such as monitoring, alerting and initiating an injection molding cycle including a control device that is used as a standalone device for performing conventional functions such as signaling and instructing an individual injection valve or a series of interdependent valves to start an injection, namely move an actuator and associated valve pin from a gate closed to a gate open position. In addition, although fluid driven actuators are employed in typical or preferred embodiments of the invention, actuators powered by an electric or electronic motor or drive source can alternatively be used as the actuator component.

As shown in FIGS. 2A-2AA, 2B, a supply of hydraulic fluid 14 is fed first through a directional control valve 750 mechanism that switches the hydraulic fluid flow to the actuator cylinders in either of two directions: fluid out to withdraw the pin upstream, FIG. 2A, 2AA. When a cycle is started, the directional configuration of the directional valve 750 of the hydraulic system 700 is switched by controller 16 to the configuration of FIG. 2A or 2AA. The hydraulic system includes a flow restriction valve 600 that is controlled by controller 16 to vary the rate of flow of hydraulic fluid to the actuator 941, 951 to vary the rate of travel of the actuator 941/valve pin 1041 upstream according to a predetermined pressure profile (e.g. FIGS. 5AA, 5AAA, 5BB, 5BBB) or to drive the actuator 941/valve pin 1041 downstream. Although not shown in FIGS. 2A, 2B, the controller 16 and hydraulic system 700 can control the direction and rate of travel of the pistons of actuators 940 and 942 in a manner similar to the manner of control of actuator 941 via the connections shown in FIG. 1.

The user programs controller 16 via data inputs on a user interface to instruct the hydraulic system 700 via control of the degree of openness of the restriction valve 600 to drive pins 1041, 1042 at an upstream velocity of travel that is reduced relative to a maximum velocity that the hydraulic system 700 can drive the pins 1041, 1042 to travel. The reduced velocity at which the actuator 941 and associated valve pin 1041 are driven is determined by a predetermined profile of reduced drive fluid pressures that is followed by the controller 16 based on the metered pressure exiting valve 600 that is sensed by sensor 603 in line 703 and sent to the controller 16 during an injection cycle, the controller 16 controlling the degree of openness of valve 600 which in turn controls the degree of pressure exiting valve 600 in line 703.

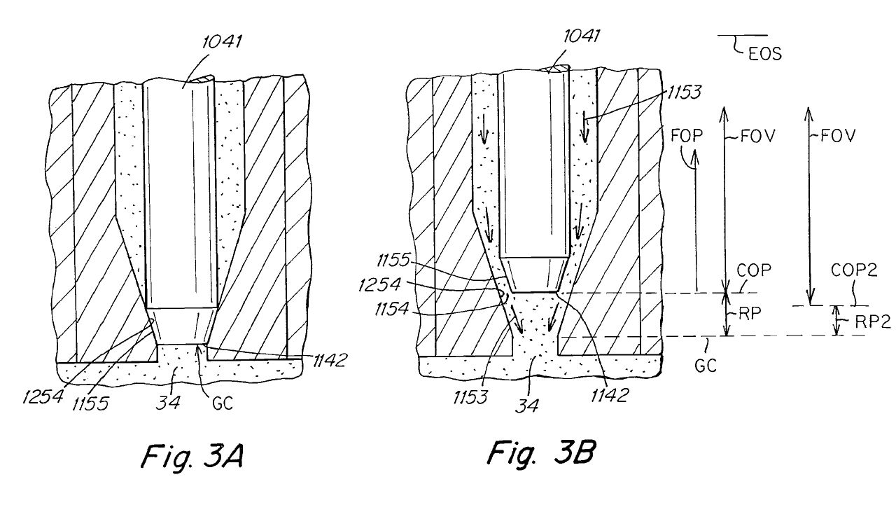

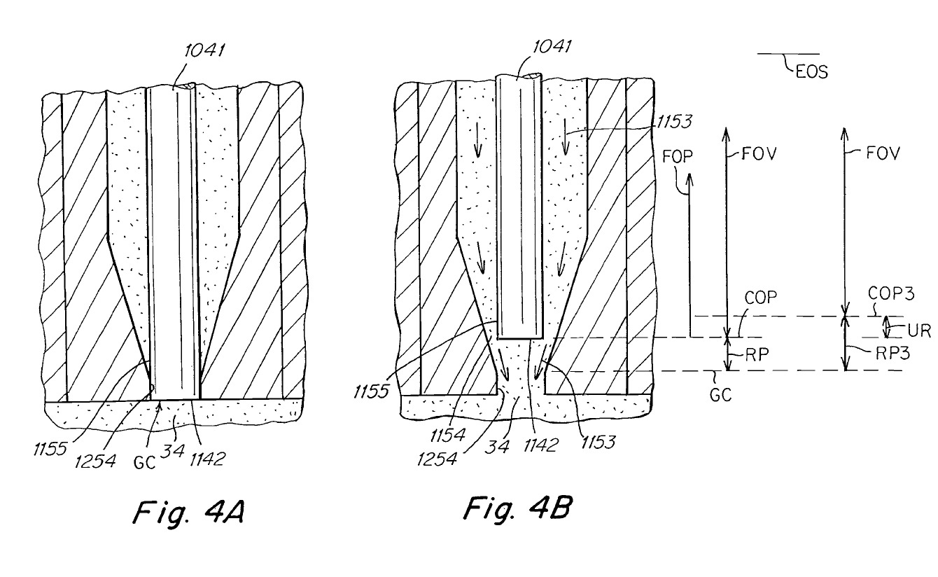

As described below, the controller 16 drives the actuator 941/valve pin 1041 at the profile of reduced pin withdrawal rate or velocity either until a position sensor such as 951, 952 detects that an actuator 941, 952 or an associated valve pin (or another component), has reached a certain position (e.g. as in FIGS. 5AA, 5BB) as sensed by the position sensor 951, 952 such as at the end point COP, COP2, FIGS. 3B, 4B of a restricted flow path RP, RP2,

In an alternative embodiment, the user can program controller 16 via to instruct the hydraulic system 700 to drive pins 1041, 1042 at the profile of reduced velocity of upstream travel for a predetermined amount of time. In such an embodiment, the reduced pin withdrawal rate or velocity is executed for a preselected amount of time that is less than the time of the entire injection cycle, the latter part of the injection cycle being executed with the pins 1041, 1042 being withdrawn at a higher velocity typically the highest velocity at which the hydraulic system is capable of driving the pins 1041, 1042. A typical amount of time over which the pins are instructed to withdraw at a reduced velocity is between about 0.25 and about 10 seconds, more typically between about 0.5 and about 5 seconds, the entire injection cycle time typically being between about 4 seconds and about 30 seconds, more typically between about 6 seconds and about 12 seconds. In such an embodiment, the periods of time over which the pins 1041, 1042 are withdrawn at reduced velocities are typically determined empirically by trial and error runs. One or more, typically multiple, trial injection cycle runs are carried out to make specimen parts from the mold. Each trial injection cycle run is carried out using a different period or periods of time at which the pins 1041, 1042 are withdrawn at one or more reduced velocities over the trial period(s) of time, and the quality of the parts produced from all such trial runs are compared to determine the optimum quality producing time(s) of reduced velocity pin withdrawals. When the optimum time(s) have been determined, the controller is programmed to carry out an injection cycle where the pin withdrawal velocities of pins 1041 are reduced for the predetermined amounts of time at the predetermined reduced withdrawal rates.

FIG. 1 shows position sensors 950, 951, 952 for sensing the position of the actuator cylinders 941, 942, 952 and their associated valve pins (such as 1041, 1042, 1052) and feed such position information to controller 16 for monitoring purposes. As shown, fluid material 18 is injected from an injection machine into a manifold runner 19 and further downstream into the bores 44, 46 of the lateral nozzles 24, 22 and ultimately downstream through the gates 32, 34, 36. When the pins 1041, 1042 are withdrawn upstream to a position where the tip end of the pins 1041 are in a fully upstream open position such as shown in FIG. 1D, the rate of flow of fluid material through the gates 34, 36 is at a maximum. However when the pins 1041, 1042 are initially withdrawn beginning from the closed gate position, FIG. 1A, to intermediate upstream positions, FIGS. 1B, 1C, a gap 1154, 1156 that restricts the velocity of fluid material flow is formed between the outer surfaces 1155 of the tip end of the pins 1041, 1042 and the inner surfaces 1254, 1256 of the gate areas of the nozzles 24, 20. The restricted flow gap 1154, 1156 remains small enough to restrict and reduce the rate of flow of fluid material 1153 through gates 34, 36 to a rate that is less than maximum flow velocity over a travel distance RP of the tip end of the pins 1041, 1042 going from closed to upstream as shown in FIGS. 1, 1B, 1C, 1E and 3B, 4B.

The pins 1041 can be controllably withdrawn at one or more reduced velocities (less than maximum) for one or more periods of time over the entirety of the length of the path RP over which flow of mold material 1153 is restricted. Preferably the pins are withdrawn at a reduced velocity over more than about 50% of RP and most preferably over more than about 75% of the length RP. As described below with reference to FIGS. 3B, 4B, the pins 1041 can be withdrawn at a higher or maximum velocity at the end COP2 of a less than complete restricted mold material flow path RP2.

The trace or visible lines that appear in the body of a part that is ultimately formed within the cavity of the mold on cooling above can be reduced or eliminated by reducing or controlling the velocity of the pin 1041, 1042 opening or upstream withdrawal from the gate closed position to a selected intermediate upstream gate open position that is preferably 75% or more of the length of RP.

RP can be about 1-8 mm in length and more typically about 2-6 mm and even more typically 2-4 mm in length. As shown in FIG. 2 in such an embodiment, a control system or controller 16 is preprogrammed to control the sequence and the rates of valve pin 1040, 1041, 1042 opening and closing. The controller 16 controls the rate of travel, namely velocity of upstream travel, of a valve pin 1041, 1042 from its gate closed position for at least the predetermined amount of time that is selected to withdraw the pin at the selected reduced velocity rate.

The velocity of withdrawal of the valve pins 1041, 1042 is determined by regulation of the flow of hydraulic drive fluid that is pumped from a supply 14 to the actuators 941, 942 through flow restrictor valve 600, FIGS. 1, 2, 2A, 2B. When the flow restrictor valve 600 is completely open, namely 100% open, allowing maximum flow of the pressurized hydraulic fluid to the actuator cylinders, the valve pins 1041, 1042 are driven at a maximum upstream travel velocity.

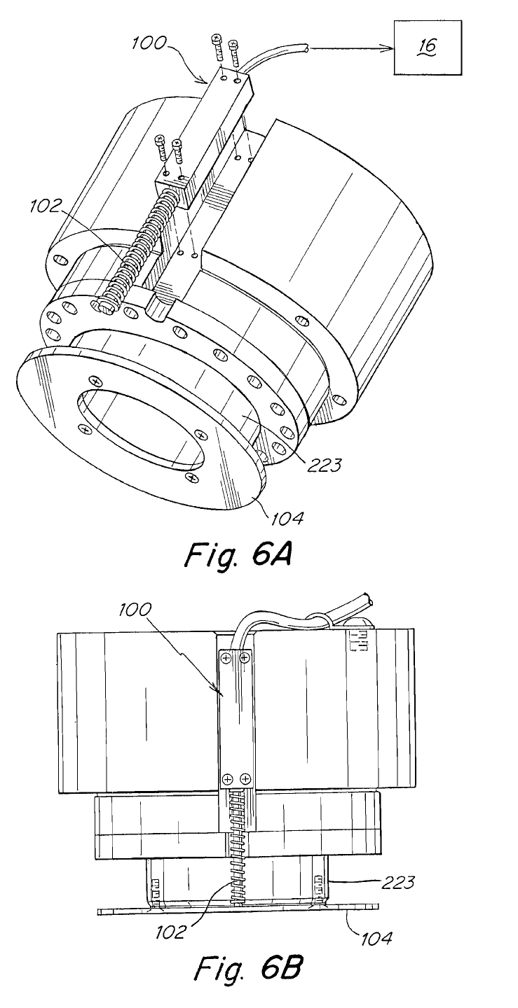

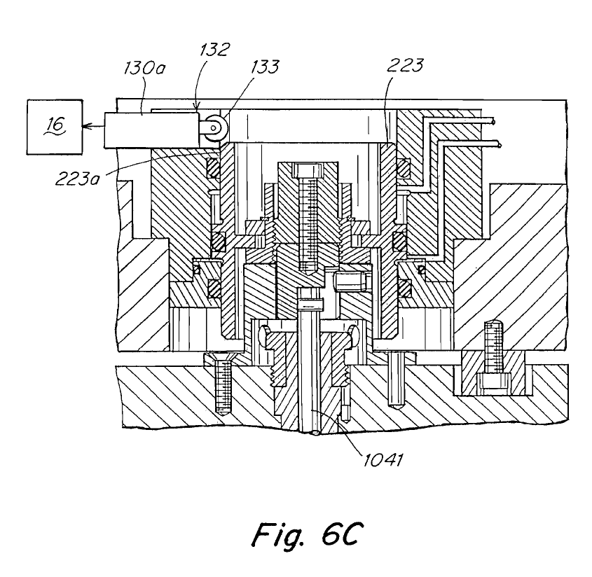

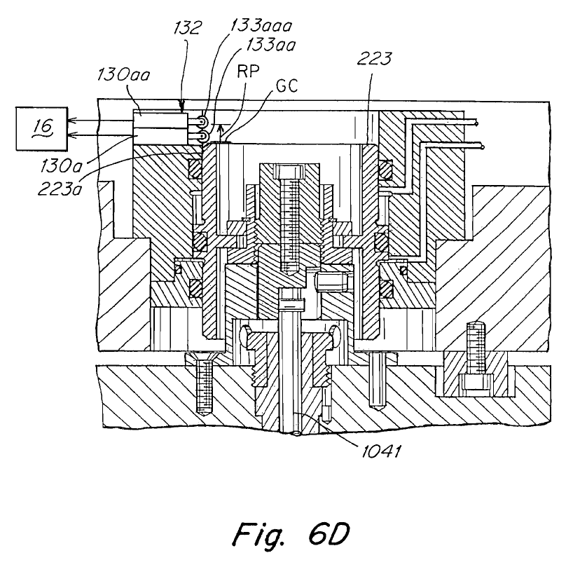

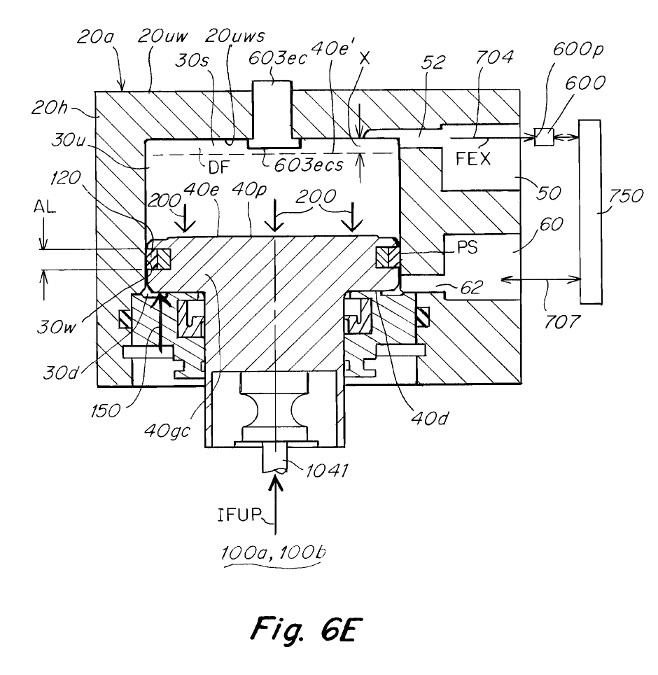

According to the invention, the degree of openness of the flow restrictor valve 600 is adjusted in response to sensing with sensors 603, 603e, 603ec, FIGS. 2A-2B, FIG. 6E of the drive fluid pressure of the drive fluid that exits either restrictor valve 600 or that exits the upstream drive fluid chamber 30u of the actuator 20a. The controller 16 automatically adjusts the degree of openness of flow restrictor valve 600 to less than 100% open to cause the reduced pressure in line 703 to match and follow the predetermined profile of pressure shown for example in FIGS. 5AA, 5AAA, 5BB, 5BBB which in turn adjusts rate and volume flow of pressurized hydraulic fluid to the actuator cylinders which in turn adjusts the velocity of upstream travel of the pins 1041, 1042 according to the predetermined exit pressure in line 703 for either a selected period of time as in FIG. 5AAA or 5BBB or until the actuator/valve pin has travelled upstream to a predetermined position as in FIGS. 5AA, 5BB, the predetermined upstream position being sensed by a position sensor 951, 952, 950 and signalling controller 16. Upon expiration of the predetermined amount of time (FIGS. 5AAA, 5BBB) or upon reaching the predetermined upstream position (FIGS. 5AA, 5BB), the controller 16 instructs the metering valve to open to a greater degree of openness to drive the actuator 941/pin 1041 at a higher velocity typically to the highest degree of openness of the valve 600 and thus the highest possible velocity.

In the FIGS. 5AA, 5BB embodiment, the actuator/valve pin travels the predetermined length of the reduced velocity path RP, RP2, at the end of which the position sensor signals the controller 16 whereby the controller 16 determines that the end COP, COP2 has been reached and the valve 600 is opened to a higher velocity, typically to its 100% open position to allow the actuator pistons and the valve pins 1041, 1042 to be driven at maximum upstream velocity FOV in order to reduce the cycle time of the injection cycle.

The valve 600 typically comprises a restrictor valve that is controllably positionable anywhere between completely closed (0% open) and completely open (100% open). Adjustment of the position of the restrictor valve 600 is typically accomplished via a source of electrical power that controllably drives an electromechanical mechanism that causes the valve to rotate such as a rotating spool that reacts to a magnetic or electromagnetic field created by the electrical signal output of the controller 16, namely an output of electrical energy, electrical power, voltage, current or amperage the degree or amount of which can be readily and controllably varied by conventional electrical output devices. The electro-mechanism is controllably drivable to cause the valve 600 to open or close to a degree of openness that is proportional to the amount or degree of electrical energy that is input to drive the electro-mechanism. The velocity of upstream withdrawal travel of the pins 1041, 1042 are in turn proportional to the degree of openness of the valve 600. Thus the rate of upstream travel of the pins 1041, 1042 is proportional to the amount or degree of electrical energy that is input to the electro-mechanism drives valves 600. The electro-mechanism that is selected for driving the valve 600 establishes in the first instance the maximum amount of electrical energy or power (such as voltage or current) that is required to open the valve to its 100% open position.

The user can implement a reduced upstream velocity of the pins 1041, 1042 over a given upstream length of travel or over a given amount of time by inputting to the controller 16 a profile of reduced exit fluid pressures that are implemented by adjusting the electrical drive mechanism that operates metering valve 600 to less than 100% of the maximum amount of electrical energy or power input (voltage or current) needed to open the valve 600 to 100% open at which setting maximum drive fluid pressure and, a fortiori, maximum actuator/pin velocity occurs.

In one embodiment, the user can implement reduced actuator/pin withdrawal velocity profiles by inputting reduced exit pressure profiles (or other data corresponding thereto) versus actuator/pin position into the controller 16. Exit pressure is the pressure of the valve drive fluid that exits either the metering valve 600 or the upstream drive chamber 30u of the actuator 20a during the upstream withdrawal portion of the injection cycle. In the examples provided, the exit pressure would be the pressure in one of lines 703, 705 or 707 as sensed by a respective one of sensors 603, 605, 607 or as sensed by a sensor 603ec, 603e in the actuator chamber 30u, 30s or in the drive fluid line interconnecting and between the input port 600p of valve 600 and the drive chamber 30u. In another embodiment, the user can implement reduced actuator/pin withdrawal velocity profiles by inputting to the controller 16 reduced exit pressure profiles or other data corresponding thereto) versus time of withdrawal beginning from the time at which the gate is closed.

The user can also preselect the length of the path of travel RP, RP2 of the valve pin or other end of reduced velocity position of the valve pin or other component over the course of travel of which the material flow through the gate is restricted and input such selections into the controller 16. In an alternative embodiment the user can preselect the length of time during which the gate is restricted by a valve pin travelling over a restricted path length RP, RP2 and input such a selection into the controller 16.

The controller 16 includes conventional programming or circuitry that receives and executes the user inputs. The controller may include programming or circuitry that enables the user to input as a variable a selected pin velocity rather than a percentage of electrical output, the programming of the controller 16 automatically converting the inputs by the user to appropriate instructions for reduced energy input to the electro-mechanism that drives the valve 600.

Typically the user selects a profile of metered exit drive fluid pressures that corresponds to reduced pin withdrawal velocities that are less than about 90% of the maximum velocity (namely the velocity when the valve 600 is fully open), more typically less than about 75% of the maximum velocity and even more typically less than about 50% of the maximum velocity at which the pins 1041, 1042 are drivable by the hydraulic system. The actual maximum velocity at which the actuators 941, 942 and their associated pins 1041, 1042 are driven is predetermined by selection of the size and configuration of the actuators 20a, 941, 942, the size and configuration of the restriction valve 600 and the degree of pressurization and type of hydraulic drive fluid selected for use by the user. The maximum drive rate of the hydraulic system is predetermined by the manufacturer and the user of the system and is typically selected according to the application, size and nature of the mold and the injection molded part to be fabricated.

As shown by the series of examples of programs illustrated in FIGS. 5A, 5B, 5c, 5D one or more profiles of reduced pin withdrawal velocity can be selected and the pin driven by restricted hydraulic fluid flow between the gate closed (X and Y axis zero position) and the final intermediate upstream open gate position (4 mm for example in the FIG. 5A example, 5 mm in the FIG. 5B example) at which point the controller 16 in response to position sensing instructs the drive system to drive pin 1041, 1042 to travel upstream at a higher, typically maximum, upstream travel velocity (as shown, 100 mm/sec in the FIGS. 5A-5D examples). In the FIGS. 5A, 5B examples, the profile of reduced pin velocity is selected as being about 50, 25 and 75 mm/sec over the initial reduced velocity path length. In practice the velocity of the pin may or may not be precisely known, the Y velocity axis of FIGS. 5A, 5B corresponding to the drive fluid pressure profile of FIGS. 5AA, 5AAA, 5BB, 5BBB, the degree of precision in control over which depends and may vary slightly with the degree of precision in control over the opening of the flow restriction valve 600, 100 mm/sec corresponding to the valve 600 being completely 100% open (and pin being driven at maximum velocity); and 50 mm/sec corresponding to 50% electrical energy input to the electromechanism that drives the restriction valve 600 to one-half of its maximum 100% degree of openness. In the FIG. 5A example, the path length RP over which the valve pin 1041, 1042 travels at the reduced 50 mm/sec velocity is 4 mm. After the pin 1041, 1042 has been driven to the upstream position COP position of about 4 mm from the gate closed GC position, the controller 16 instructs the electro-mechanism that drives the valve 600 (typically a magnetic or electromagnetic field driven device such as a spool) to open the restrictor valve 600 to full 100% open at which time the pin (and its associated actuator piston) are driven by the hydraulic system at the maximum travel rate 100 mm/sec for the predetermined, given pressurized hydraulic system.

FIGS. 5B-5D illustrate a variety of alternative profiles for driving the pin 1041, 1042 at reduced velocities for various durations of time. For example as shown in FIG. 5B, the pin is driven for 0.02 seconds at 25 mm/sec, then for 0.06 seconds at 75 mm/sec and then allowed to go to full valve open velocity shown as 100 mm/sec. Full valve open or maximum velocity is typically determined by the nature of hydraulic (or pneumatic) valve or motor drive system that drives the valve pin. In the case of a hydraulic (or pneumatic) system the maximum velocity that the system is capable of implementing is determined by the nature, design and size of the pumps, the fluid delivery channels, the actuator, the drive fluid (liquid or gas), the restrictor valves and the like. The velocity profiles shown in the plots or graphs of FIGS. 5A, 5B, 5C, 5D can be calculated, correlated and converted by the controller 16 to and from a corresponding profile of drive fluid pressures that are detected, recorded and monitored with respect to the metered pressure of actuator drive fluid that drives the actuators (hydraulic or pneumatic).

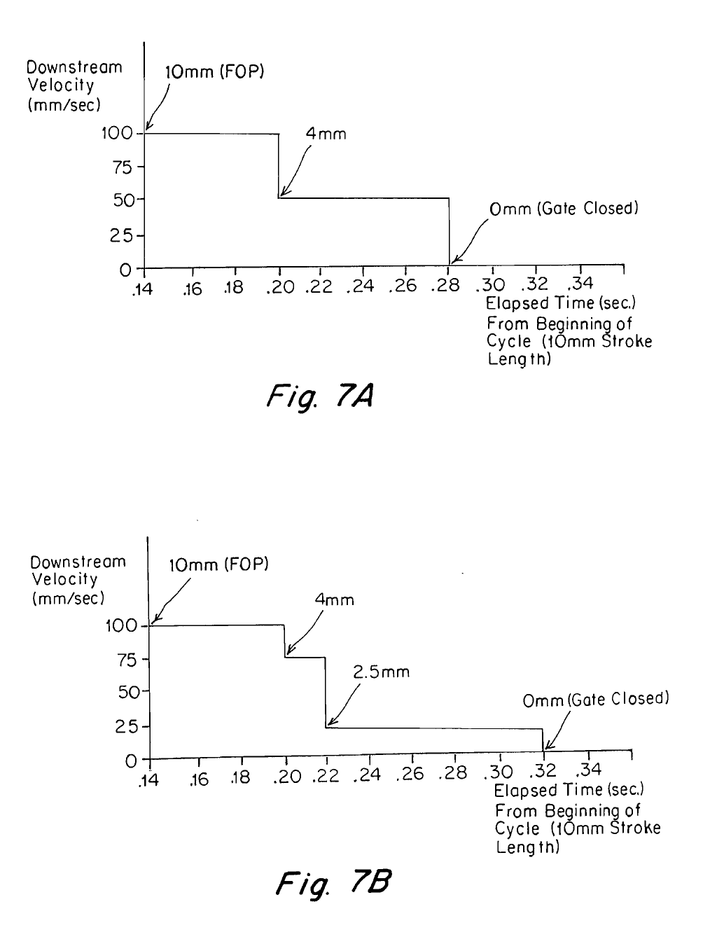

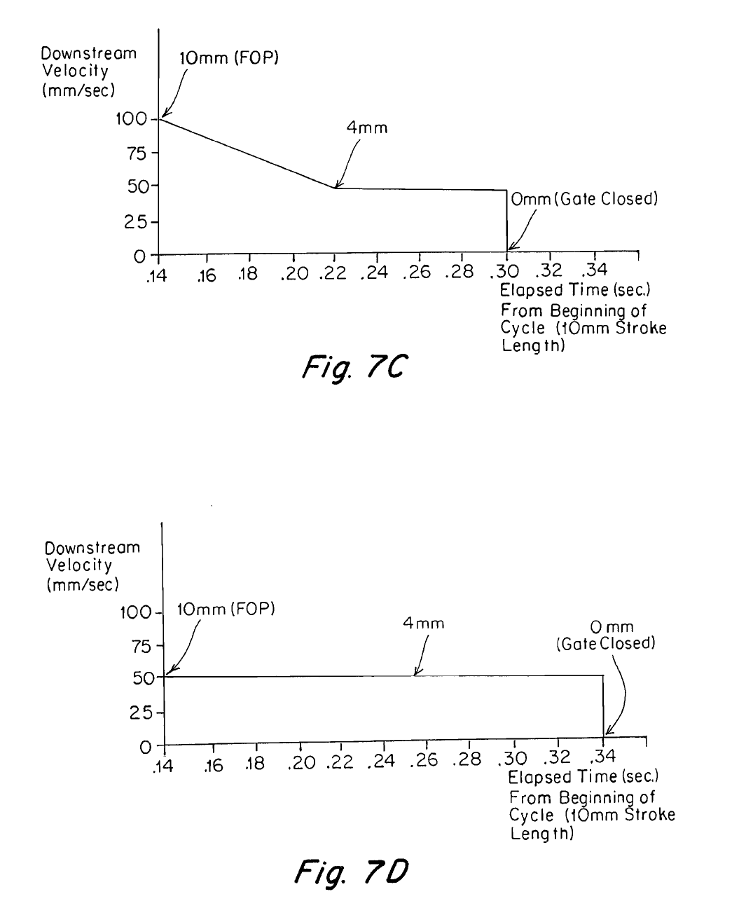

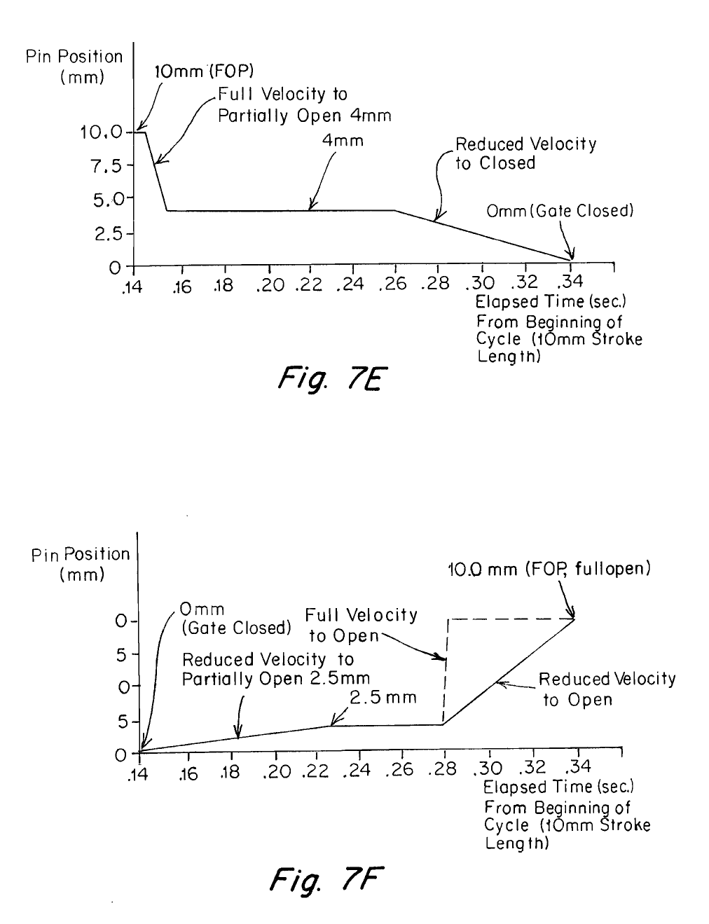

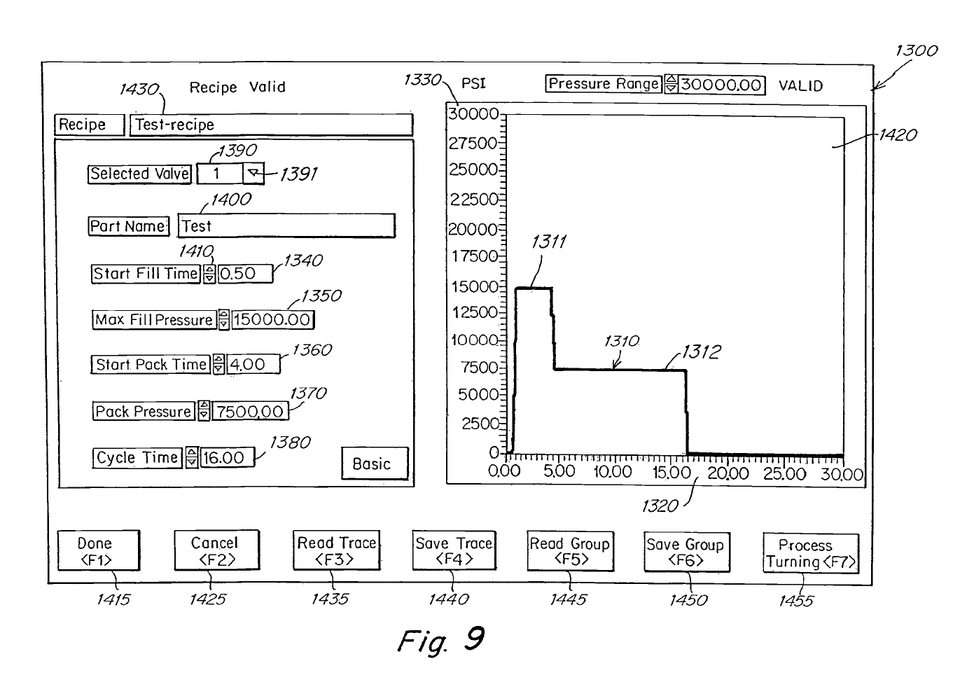

As shown in FIGS. 5A-5D, the velocity of the valve pin when the pin reaches the end of the reduced velocity period, the valve 600 can be instructed to assume the full open position essentially instantaneously or alternatively can be instructed to take a more gradual approach up, between 0.08 and 0.12 seconds, to the maximum valve openness as shown in FIG. 5D. In an alternative pin movement protocol shown in FIGS. 7E, 7F, 9A-9D, 10, the tip end of the pin is driven either continuously upstream or continuously downstream with the tip end of the pin being held or maintained in a position intermediate the full open and gate closed positions for some selected period of time during the course of travel between full open and gate closed. In the FIG. 10 protocol example the pin is held in an intermediate reduced injection flow position (a pack position) for between about 4 seconds and about 15.9 second. In the FIG. 9A protocol example the pin is held in an intermediate (pack) reduced injection fluid flow position for between about 3 seconds and about 6.39 seconds. In the FIG. 7E example protocol the pin is held in an intermediate reduced flow 4 mm position for between about 0.15 and about 0.26 seconds. In all cases the controller 16 instructs the valve pin 1041, 1042, 1040 to travel either (a) continuously upstream during the upstream travel portion of the cycle rather than follow a drive fluid pressure, pin position or injection fluid pressure profile where the pin might travel in a downstream direction during the course of the upstream travel portion of the injection cycle, or (b) continuously downstream during the downstream travel portion of the cycle rather than follow a profile where the pin travels upstream during the course of the downstream travel portion of the injection cycle.

Most preferably, the actuator, valve pin, valves and fluid drive system are adapted to move the valve pin between a gate closed position and a maximum upstream travel position that defines an end of stroke position for the actuator and the valve pin. Most preferably the valve pin is moved at the maximum velocity at one or more times or positions over the course of upstream travel of the valve pin past the upstream gate open position. Alternatively to the hydraulic system depicted and described, a pneumatic or gas driven system can be used and implemented in the same manner as described above for a hydraulic system.

Preferably, the valve pin and the gate are configured or adapted to cooperate with each other to restrict and vary the rate of flow of fluid material 1153, FIGS. 3A-3B, 4A-4B over the course of travel of the tip end of the valve pin through the restricted velocity path RP. Most typically as shown in FIGS. 3A, 3B the radial tip end surface 1155 of the end 1142 of pin 1041, 1042 is conical or tapered and the surface of the gate 1254 with which pin surface 1155 is intended to mate to close the gate 34 is complementary in conical or taper configuration. Alternatively as shown in FIGS. 4A, 4B, the radial surface 1155 of the tip end 1142 of the pin 1041, 1042 can be cylindrical in configuration and the gate can have a complementary cylindrical surface 1254 with which the tip end surface 1155 mates to close the gate 34 when the pin 1041 is in the downstream gate closed position. In any embodiment, the outside radial surface 1155 of the tip end 1142 of the pin 1041 creates restricted a restricted flow channel 1154 over the length of travel of the tip end 1142 through and along restricted flow path RP that restricts or reduces the volume or rate of flow of fluid material 1153 relative to the rate of flow when the pin 1041, 1042 is at a full gate open position, namely when the tip end 1142 of the pin 1041 has travelled to or beyond the length of the restricted flow path RP (which is, for example the 4 mm upstream travel position of FIGS. 5A-5C).

In one embodiment, as the tip end 1142 of the pin 1041 continues to travel upstream from the gate closed GC position (as shown for example in FIGS. 3A, 4A) through the length of the RP path (namely the path travelled for the predetermined amount of time), the rate of material fluid flow 1153 through restriction gap 1154 through the gate 34 into the cavity 30 continues to increase from 0 at gate closed GC position to a maximum flow rate when the tip end 1142 of the pin reaches a position FOP (full open position), FIGS. 5A-5D, where the pin is no longer restricting flow of injection mold material through the gate. In such an embodiment, at the expiration of the predetermined amount of time when the pin tip 1142 reaches the FOP (full open) position FIGS. 5A, 5B, the pin 1041 is immediately driven by the hydraulic system at maximum velocity FOV (full open velocity) typically such that the restriction valve 600 is opened to full 100% open.

In embodiments, where the tip 1142 has reached the end of restricted flow path RP2 and the tip 1142 is not necessarily in a position where the fluid flow 1153 is not still being restricted, the fluid flow 1153 can still be restricted to less than maximum flow when the pin has reached the changeover position COP2 where the pin 1041 is driven at a higher, typically maximum, upstream velocity FOV. In the examples shown in the FIGS. 3B, 4B examples, when the pin has travelled the predetermined path length at reduced velocity and the tip end 1142 has reached the changeover point COP, the tip end 1142 of the pin 1041 (and its radial surface 1155) no longer restricts the rate of flow of fluid material 1153 through the gap 1154 because the gap 1154 has increased to a size that no longer restricts fluid flow 1153 below the maximum flow rate of material 1153. Thus in one of the examples shown in FIG. 3B the maximum fluid flow rate for injection material 1153 is reached at the upstream position COP of the tip end 1142. In another example shown in FIG. 3B 4B, the pin 1041 can be driven at a reduced velocity over a shorter path RP2 that is less than the entire length of the restricted mold material flow path RP and switched over at the end COP2 of the shorter restricted path RP2 to a higher or maximum velocity FOV. In the FIGS. 5A, 5B examples, the upstream FOP position is about 4 mm and 5 mm respectively upstream from the gate closed position. Other alternative upstream FOP positions are shown in FIGS. 5C, 5D.

In another alternative embodiment, shown in FIG. 4B, the pin 1041 can be driven and instructed to be driven at reduced or less than maximum velocity over a longer path length RP3 having an upstream portion UR where the flow of injection fluid mold material is not restricted but flows at a maximum rate through the gate 34 for the given injection mold system. In this FIG. 4B example the velocity or drive rate of the pin 1041 is not changed over until the tip end of the pin 1041 or actuator 941 has reached the changeover position COP3. In this embodiment, a position sensor senses either that the valve pin 1041 or an associated component has travelled the path length RP3 or reached the end COP3 of the selected path length and the controller receives and processes such information and instructs the drive system to drive the pin 1041 at a higher, typically maximum velocity upstream. In another alternative embodiment, the pin 1041 can be driven at a less than maximum velocity throughout the entirety of the travel path of the pin during an injection cycle from the gate closed position GC up to the end-of-stroke EOS position, the controller 16 being programmed to instruct the drive system for the actuator to be driven at one reduced velocity for an initial path length or period of time and at another less than maximum velocity subsequent to the intial reduced velocity path or period of time for the remainder of the injection cycle whereby the actuator/valve pin travels at a less than maximum velocity for an entire closed GC to fully open EOS cycle.

In the FIGS. 5A-5D examples, FOV is 100 mm/sec. Typically, when the time period or path length for driving the pin 1041 at reduced velocity has expired or been reach and the pin tip 1142 has reached the position COP, COP2, the restriction valve 600 is opened to full 100% open velocity FOV position such that the pins 1041, 1042 are driven at the maximum velocity or rate of travel that the hydraulic system is capable of driving the actuators 941, 942. Alternatively, the pins 1041, 1042 can be driven at a preselected FOV velocity that is less than the maximum velocity at which the pin is capable of being driven when the restriction valve 600 is fully open but is still greater than the selected reduced velocities that the pin is driven over the course of the RP, RP2 path to the COP, COP2 position.

At the expiration of the predetermined reduced velocity drive time, the pins 1041, 1042 are typically driven further upstream past the COP, COP2 position to a maximum end-of-stroke EOS position. The upstream COP, COP2 position is downstream of the maximum upstream end-of-stroke EOS open position of the tip end 1142 of the pin. The length of the path RP or RP2 is typically between about 2 and about 8 mm, more typically between about 2 and about 6 mm and most typically between about 2 and about 4 mm. In practice the maximum upstream (end of stroke) open position EOS of the pin 1041, 1042 ranges from about 8 mm to about 18 inches upstream from the closed gate position GC.

The controller 16 includes a processor, memory, user interface and circuitry and/or instructions that receive and execute the user inputs of percentage of maximum valve open or percentage of maximum voltage or current input to the motor drive for opening and closing the restriction valve, time duration for driving the valve pin at the selected valve openings and reduced velocities.

With regard to embodiments where the use of a position sensor is employed, FIGS. 6A-6D show various examples of position sensors 100, 114, 227, 132 the mounting and operation of which are described in U.S. Patent Publication no. 20090061034 the disclosure of which is incorporated herein by reference. As shown the position sensor of FIGS. 6A and 6B for example can track and signal the position of the piston of the actuator piston 223 continuously along its entire path of travel from which data pin velocity can be continuously calculated over the length of RP, RP2, RP3 via spring loaded follower 102 that is in constant engagement with flange 104 during the course of travel of piston 223. Mechanism 100 constantly sends signals to controller 16 in real time to report the position of pin 1041 and its associated actuator. FIGS. 6C, 6D show alternative embodiments using position switches that detect position at specific individual positions of the actuator and its associated valve pin 1041. The FIG. 6C embodiment uses a single trip position switch 130a with trip mechanism 133 that physically engages with the piston surface 223a when the piston 223 reaches the position of the trip mechanism 133. The FIG. 6D embodiment shows the use of two separate position switches 130a, 130aa having sequentially spaced trips 133aa and 133aaa that report the difference in time or distance between each trip engaging surface 223a of the piston, the data from which can be used by controller 16 to calculate velocity of the actuator based on the time of travel of the actuator from tripping one switch 130a and then tripping the next 130aa. In each embodiment the position switch can signal the controller 16 when the valve pin 1041, 1042 has travelled to one or more selected intermediate upstream gate open positions between GC and RP, RP2 or RP3 so that the velocity of the pin can be adjusted to the selected or predetermined velocities determined by the user. As can be readily imagined other position sensor mechanisms can be used such as optical sensors, sensors that mechanically or electronically detect the movement of the valve pin or actuator or the movement of another component of the apparatus that corresponds to movement of the actuator or valve pin.

FIG. 6E illustrates in greater detail in schematic cross section an embodiment where a fluid pressure sensor 603ec is disposed such that the sensor 603ec measures the pressure of actuator drive fluid disposed in the upstream drive chamber 30us of fluid driven actuator. In the FIG. 6E embodiment the actuator 20a (corresponding to actuators 940, 941, 942) has a pressure sensor 603ec that is mounted to the actuator housing 20h in an arrangement where the pressure sensing surface 603ecs of the sensor 603ec extends through the housing 20h to make contact with and measure the pressure of drive fluid DF that resides in the interior volume or space 30s of the upper drive chamber as well as drive fluid that resides within the fluid flow line 704 that extends and interconnects between the upstream chamber port 50 of the drive chamber 30u and the entry port 600p to the restriction valve 600.

The actuator 20a as shown comprises a housing 20h and a piston 40 having an O-ring or other fluid seal mechanism 120 mounted in a circumferential groove formed in the circumferential surface of the piston head that extends around the circumference of the piston 40. The O-ring or fluid seal mechanism 120 is typically comprised of a highly friction resistant polymeric material that is resiliently compressible. The O-ring or seal 120 is formed and adapted to be seated within a complementary groove such that the O-Ring compressibly engages against the inner wall surface 30w of chamber 30 to form a circumferential seal surface PS that forms two opposing fluid sealed upstream chamber 30u and downstream chamber 30d within master chamber 30. The upstream drive chamber 30u is interconnected to and communicates with a source of pressurized fluid 200f (typically hydraulic oil or gas such as air) via fluid delivery ports 50, 52 which when pumped into chamber 30u exerts a downstream force 200 on the upstream end 40e of piston 40. Piston 40 can conversely be driven upstream by pumping pressurized hydraulic fluid 200f through ports 60, 62 into downstream chamber 30d thus exerting upstream drive force 150 on the downstream surface 40d of the piston 40.

As shown in FIGS. 2A, 2AA, 2B, a fluid pressure sensor 603e can alternatively be mounted such that the sensing surface of the sensor 603e is disposed within the drive fluid flow channel 704 that extends between and interconnects the exit 50 of the upper actuator drive chamber 30u and the entry port 600p of the restrictor valve 600 thus sensing and measuring the pressure of the drive fluid disposed within the upstream drive fluid flow channel 704, the sensed pressure of the drive fluid DF therein being indicative of the pressure of the injection fluid 100a, 100b resident within the cavity and exerting pressure IFUP on the distal tip end of the valve pin 1041. In the FIGS. 2A, 2AA, 2B embodiment, as in the FIG. 6E embodiment, the restriction valve 600 is first closed such the drive fluid DF remains static under pressure within the flow channel 704, and the sensor 603e senses the pressure of the static drive fluid DF which is indicative of the pressure IFUP of the injection fluid 100a, 100b exerted on the tip end 1142 of the valve pin 1041.

In the FIGS. 2A, 2AA, 2B and 6E embodiments, the pressure sensor 603e, 603ec senses the pressure of the drive fluid DF that has exited drive fluid chamber 30u and is indicative of pressure of drive fluid DF that is resident either within the upstream piston drive chamber 30u or at any position within the flow channel 704 between the upstream position drive chamber 30u and the inlet port 600p, FIG. 6E, of the metering valve 600 to which the piston drive chamber 30u is sealably interconnected.

In these embodiments, the fluid pressure that the sensors 603e, 603ec are sensing is more accurately indicative of the injection fluid pressure IFUP of the injection fluid 100a, 100b that is being exerted on the tip end 1142 of the valve pin 1041 by the injection fluid during the course of the injection fluid. Fluid pressure that is disposed in the exiting drive fluid stream that is upstream of the metering valves 600 that is sensed by the sensors 603, 605, 705 does not account accurately for the injection fluid pressure IFUP exerted on the drive fluid pressure through the valve pin in the same manner as the sensors 603e or 603ecdetect such pressure in the drive fluid that is resident in the upper drive chamber 30u or fluid flow channel 704 that is downstream of the port 600p to a restrictor valve 600.

In the FIGS. 6E, 2A, 2AA, 2BB embodiments, the controller 16 is programmed to drive the piston 40p of an actuator 940, 941 for a preselected portion of the duration of the injection cycle to a preselected maximum upstream position where the upstream surface 40e′ of the piston 40 is spaced a minimum axial distance X greater than about 0.05 mm, preferably between about 0.25 mm and about 1.0 mm, most preferably between about 0.25 mm and about 0.5 mm downstream from the inner upstream surface 20uws of the upstream wall 20uw of the actuator housing 20h or chamber 30u. In such an embodiment the piston 40p, FIG. 6E is driven upstream from a gate closed position to an axial position that is close to its fully upstream position, the controller 16 being programmed to stop the upstream travel of the piston 40p such that the top surface 40e′ of the piston 40p is always spaced during the entire course or duration of the injection cycle at least a minimum axial distance X away from the inner surface 20uws of the top wall 20uw such that a relatively small volume of drive fluid DF is maintained resident within an interior volume or space 30s of the upper drive chamber 30u, typically during the entire course of an injection cycle. In such an embodiment the pressurized drive fluid DF (hydraulic or pneumatic) that resides within the relatively small space 30s is static and is not exiting FEX or flowing through the restriction valve 600. In this embodiment, a fluid pressure is maintained within the space 30s during the entire course of the injection cycle such that the sensors 603e or 603ec are capable of sensing a drive fluid pressure and sending data signal PS to the controller 16 that is indicative of the pressure of drive fluid DF that resides in the upper piston chamber 30u.

In the FIGS. 2A, 2AA, 2B, 6E embodiments, the piston 40p is withdrawn at the start of the cycle from a gate closed position where the distal end 1155 of the valve pin 1041 obstructs flow through the gate upstream to an axial position where the upstream end 40e′ is spaced the preselected axial distance X from the inner undersurface 20uws of the housing 40h. The piston 40p is held or maintained stationary in this position as instructed by controller 16 by instructing the valve 600 to close for a preselected portion of the duration of the injection cycle such that the top end surface 40e′ of the piston does not engage the undersurface 20uws of the housing at any time during the entire course of the duration of the injection cycle. Thus in such an embodiment, the preselected portion of the duration of the injection cycle is selected such that the upper surface 40e of the piston never travels fully upstream into engagement with the undersurface 20uws of the housing during the entire course of the injection cycle.

In an alternative embodiment, the controller 16 can instruct the piston 40p to travel fully upstream into engagement with the undersurface 20uws subsequent to a preselected portion of the duration of the injection cycle where the valve 600 is closed and the piston 40p is held stationary in a position where the preselected axial distance X discussed above is maintained between the piston surface 40e and the undersurface 20uws. Thus in such an alternative embodiment, the controller 16 can include instructions that instruct the piston 40p to be driven completely upstream at some point during the course of an injection cycle to a position where the top surface 40e′ engages the undersurface 20uws where all of the drive fluid is driven out FEX of the upper chamber 30u and through valve 600 after the piston 40p has previously been instructed to remain stationary at a position spaced X distance as described above for a preselected portion of the duration of the injection cycle.

The program of the controller 16 can include instructions that instruct the piston 40p to travel, subsequent to instructing the piston 40p to travel to and be held for the selected period of time in the static position where the top surface 40e′ is maintained at the distance X from undersurface 20uws, to another (second) subsequent preselected axial position for another subsequent preselected period of time. Such a subsequent axial position can be selected to be a “fill” position where the distal end 1155 of the valve pin 1041 is positioned relative to the gate such that flow of injection fluid 100a, 100b is not significantly restricted and injection fluid 100a, 100b flows at a relatively high speed or velocity or pressure at and through the gate. Such a fill position can be selected so that injection fluid flows at the maximum velocity or pressure under or to which the drive fluid pump system is capable of pumping the drive fluid. The instructions typically execute the instruction to drive the piston to the second subsequent preselected axial position in response to receipt of a signal from the pressure sensor 603e, 603ec when the sensed signal matches a preselected target or trigger pressure that is typically preselected by a user and stored within a memory of the controller 16. The controller includes instructions that automatically compare the received pressure sensor 803e, 603ec signal to the stored target or trigger pressure and carry out instruction to drive the piston to the second subsequent preselected axial position.

Another (second or third) subsequent axial position that the piston can be driven to can be selected to be a “pack position” where the distal end 1155 of the valve pin is disposed axially intermediate the gate closed and fully gate open positions such that the end 1155 of the valve pin 1041 restricts or reduces the rate or velocity of flow or the pressure of the injection fluid 100a, 100b flowing through or exerted at the gate to a “pack rate” or “pack pressure” or some selected reduced velocity or pressure that is less than the fill rate or fill pressure. A pack rate of flow or pack pressure is typically selected such that the flow or pressure of injection fluid at or through the gate operates to prevent the injection fluid 100a, 100b from shrinking after the injection fluid 100a, 100b has travelled through the gate into the cavity and has begun to cool or has cooled down within the cavity. The instructions typically execute the instruction to drive the piston to the second or third subsequent preselected axial position in response to receipt of a signal from the pressure sensor 603e, 603ec when the sensed signal matches another (second or third) preselected target or trigger pressure that is typically preselected by a user and stored within a memory of the controller 16. The controller includes instructions that automatically compare the received pressure sensor 803e, 603ec signal to the stored (second or third) target or trigger pressure and carry out instruction to drive the piston to the another (second or third) subsequent preselected axial position.

Control over the withdrawal (upstream) velocity of actuator or pin movement can be accomplished by controlling the degree of fluid pressure that exits the metering valve 600 which in turn is controlled by controlling the degree of openness of the fluid restriction valve 600. A profile of exit fluid pressures versus time or pin position is determined in advance and input to the controller which includes a program and instructions that automatically adjust the position of valve 600 based on the real time pressure signal received from sensor 603 (or 605 or 607) to adjust the exit pressure of the drive fluid in line 703 (or 705 or 707) which in turn adjusts the rate or velocity of upstream movement of the actuator 941/valve pin 1041 (and/or actuators 1040, 1042 and valve pins 940, 942).

In an alternative embodiment, the actuators can be controlled to cause the valve pins 1041, 1042, 1043 to travel beginning from an upstream gate open position (such as the maximum upstream position), downstream at a reduced velocity for one or more portions of the downstream path of travel from the gate open to the gate closed position. Controller 16 or 176 can also include an interface that enables the user to input any selected degree of electrical energy or power needed to operate the motors 940, 941, 942 at less than full speed any portion or all of the downstream portion of an injection cycle as shown and described with reference to FIGS. 7A-7D. Thus the user can select a reduced downstream velocity of the pins 1041, 1042 over any selected portions of the pin path length from fully closed to fully open such as in FIGS. 5A-5D and vice versa between fully open and fully closed such as shown in FIGS. 7A-7D by inputting to the controller 16 or 176 the necessary data to control the motors. Most preferably the reduced velocity drive of the valve pin 1041, 1042, 1043 is selected to occur over the course of travel the tip end of the pin through all or a portion of the length of a restricted flow path RP1, RP2, RP3.

The user inputs such selections into the controller 16 or 176. Where a position sensor and a protocol for selection of the velocities over selected path lengths is used, the user also selects the length of the path of travel RP, RP2 of the valve pin or the position of the valve pin or other component over the course of travel of which the valve 600 is to be maintained partially open and inputs such selections into the controller 16 or 176. The controller 16 or 176 includes conventional programming or circuitry that receives and executes the user inputs. The controller may include programming or circuitry that enables the user to input as a variable a selected pin velocity rather than a degree of electrical energy input to the motors, the programming of the controller 16 automatically converting the inputs by the user to appropriate instructions for reduced energy input to the motors at appropriate times and pin positions as needed to carry out a pin profile such as in FIGS. 5a-5D and 7A-7D.

Typically the user selects one or more reduced pin velocities that are less than about 90% of the maximum velocity at which the motors 940, 941, 942 can drive the pins, more typically less than about 75% of the maximum velocity and even more typically less than about 50% of the maximum velocity at which the pins 1041, 1042 are drivable by the electric motors. The actual maximum velocity at which the actuators 941, 942 and their associated pins 1041, 1042 are driven is predetermined by selection of the size and configuration of the actuators 941, 942. The maximum drive rate of the motors 940, 941, 942 is predetermined by the manufacturer and the user of the motors and is typically selected according to the application, size and nature of the mold and the injection molded part to be fabricated.

In one embodiment, after the pins 1041 have been withdrawn upstream to an upstream position where the flow of injection fluid material is no longer restricted (and thus at maximum flow rate), the pins 1041 can be withdrawn at maximum rate of upstream travel or velocity in order to shorten the injection cycle time. Alternatively, when the pins 1041 have been withdrawn to a position upstream where maximum injection flow rate is occurring, the pins 1041 can continue to be withdrawn at a reduced rate of travel or velocity to ensure that injection fluid does not flow through the gates 34 at a rate that causes a defect in the molded part.

Similarly, on downstream closure of the pins 1041 after they have reached their maximum upstream withdrawal positions, the rate of travel of the pins is preferably controlled by controller 176 such that the pins 1041 travel downstream to a fully gate closed position at a reduced rate of travel or velocity that is less than the maximum rate of downstream travel or velocity over some portion or all of the stroke length between fully upstream and closed.

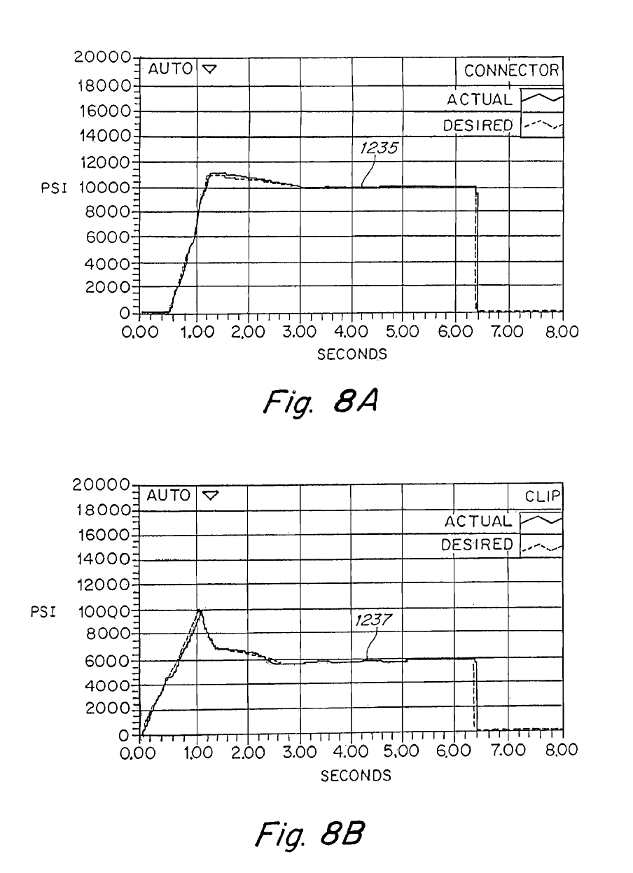

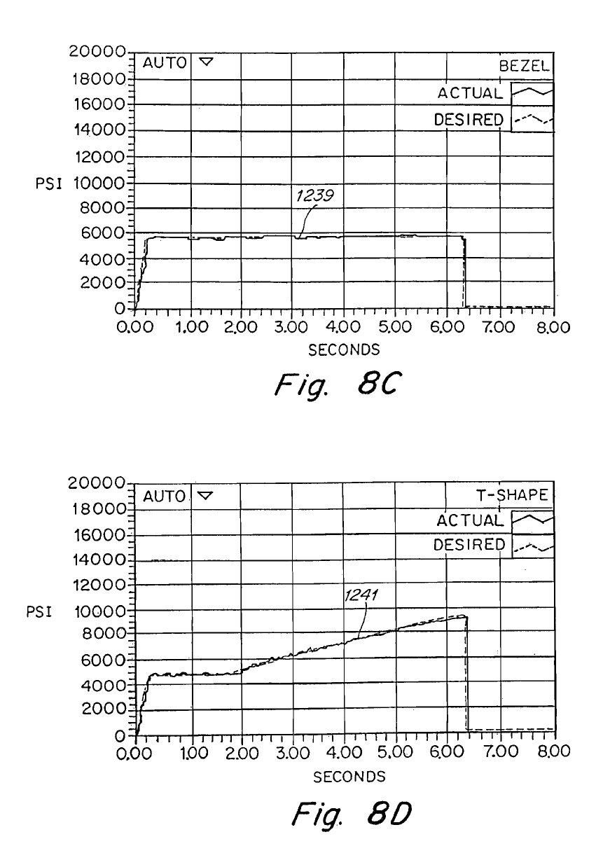

Graphs such as shown in FIGS. 8A-8D can be generated on a user interface so that a user can observe the tracking of actual pressure of the injection fluid associated with a nozzle or valve versus a preselected target pressure during the injection cycle in real time, or after the cycle is complete. The injection fluid pressure profiles shown in the plots or graphs of FIGS. 8A-8D, 10 can be calculated, correlated and converted by the controller 16 to and from a corresponding profile of drive fluid pressures that are detected and recorded with respect to the metered pressures of the actuator drive fluid that drives the actuators (hydraulic or pneumatic).

The four different graphs of FIGS. 8A-8D show four examples of independent target pressure profiles (“desired”) emulated by the injection fluid pressure associated with four individual nozzles (typically injection fluid pressure recorded and detected by a pressure sensor that is disposed to sense pressure within a mold cavity 30 downstream of one or more selected gates 32, 34, 36 of one or more nozzles or injection fluid pressure as detected and recorded within the flow channel 42, 44, 46 of a nozzle 20, 22, 24. Different target profiles can be desirable to uniformly fill different sized individual cavities associated with each nozzle, or to uniformly fill different sized sections of a single cavity. Graphs such as these can be generated with respect to any of the previous embodiments described herein.

In the FIGS. 8A-8D embodiments, a valve pin 1041, 1042, 1043 is controllably driven to reside, remain or be disposed for some selected period of time in a single steady position 1235, FIG. 8A, 1237, FIG. 8B, 1239, FIG. 8C, 1241, FIG. 8D during the course of the injection cycle. The pressure of the injection fluid associated with the particular nozzle (whether recorded within the cavity 30 or within the nozzle channel 42, 44, 46 or within a manifold channel) can be preselected and programmed to remain steady at a pressure 1235, 1237, 1239, 1241 that is selected to be reduced or less than the maximum or high pressure that occurs when the valve pins are in a fully gate open position FOP. Such reduced pressure 1235, 1237, 1239, 1241 is achieved by programming the controller 16 to move the valve pin 1041, 1042, 1040 to a position within a path of travel RP1, RP2, RP3 where flow of injection fluid through a gate 32, 34, 36 is reduced as described above. As with all other embodiments, in the embodiments of FIGS. 8A, 8B, 8C, 8D the valve pin 1041, 1042, 1040 is driven continuously either upstream or downstream without ever being driven downstream for any significant period of time during the upstream portion of the cycle and without ever being driven upstream for any significant period of time during the downstream portion of the cycle.

In the FIG. 8A example, the valve pin associated with graph 1235 is opened sequentially at 0.5 seconds after the valves associated with the other three graphs (1237, 1239 and 1241) were opened at 0.00 seconds. At approximately 6.25 seconds, at the end of the injection cycle, all four valve pins are back in the closed position. During injection (for example, 0.00 to 1.0 seconds in FIG. 8B) and pack (for example, 1.0 to 6.25 seconds in FIG. 8B) portions of the graphs, each valve pin is controlled to a plurality of positions to alter the pressure sensed by the pressure transducer associated therewith to track the target pressure.

Through a user interface, FIG. 9, target profiles can be designed, and changes can be made to any of the target profiles using standard (e.g., windows-based) editing techniques. The profiles are then used by controller 1016 to control the position of the valve pin. For example, FIG. 9 shows an example of a profile creation and editing screen 1300 generated on a user interface.

Screen 1300, FIG. 9, is generated by a windows-based application performed on the user interface, e.g., any of the user interfaces 21 shown in FIG. 1. Alternatively, this screen display could be generated on an interface associated with the controller (e.g., display 71 associated with controller 8 in FIG. 1). Interactive screen 1300 provides a user with the ability to create a new target profile or edit an existing target profile for any given nozzle and cavity associated therewith.

A profile 1310 includes (x, y) data pairs, corresponding to time values 1320 and pressure values 1330 which represent the desired pressure sensed by the pressure transducer for the particular nozzle being profiled. The screen shown in FIG. 9 is shown in a “basic” mode in which a limited group of parameters are entered to generate a profile. For example, in the foregoing embodiment, the “basic” mode permits a user to input start time displayed at 1340, maximum fill pressure displayed at 1350 (also known as injection pressure), the start of pack time displayed at 1360, the pack pressure displayed at 1370, and the total cycle time displayed at 1380.

The screen also allows the user to select the particular valve pin they are controlling displayed at 1390, and name the part being molded displayed at 1400. Each of these parameters can be adjusted independently using standard windows-based editing techniques such as using a cursor to actuate up/down arrows 1410, or by simply typing in values on a keyboard. As these parameters are entered and modified, the profile will be displayed on a graph 1420 according to the parameters selected at that time.

By clicking on a pull-down menu arrow 1391, the user can select different nozzle valves in order to create, view or edit a profile for the selected nozzle valve and cavity associated therewith. Also, a part name 1400 can be entered and displayed for each selected nozzle valve.

The newly edited profile can be saved in computer memory individually, or saved as a group of profiles for a group of nozzles that inject into a particular single or multi-cavity mold. To create a new profile or edit an existing profile, first the user selects a particular nozzle valve of the group of valves being profiled. The valve selection is displayed at 1390. The user inputs an alpha/numeric name to be associated with the profile being created, for family tool molds this may be called a part name displayed at 1400. The user then inputs a time displayed at 1340 to specify when injection starts. A delay can be with particular valve pins to sequence the opening of the valve pins and the injection of melt material into different gates of a mold.

The user then inputs the fill (injection) pressure displayed at 1350. In the basic mode, the ramp from zero pressure to max fill pressure is a fixed time, for example, 0.3 seconds. The user next inputs the start pack time to indicate when the pack phase of the injection cycle starts. The ramp from the filling phase to the packing phase is also fixed time in the basic mode, for example, 0.3 seconds.

The final parameter is the cycle time which is displayed at 1380 in which the user specifies when the pack phase (and the injection cycle) ends. The ramp from the pack phase to zero pressure may be instantaneous when a valve pin is used to close the gate, or slower in a thermal gate due to the residual pressure in the cavity which will decay to zero pressure once the part solidifies in the mold cavity.

User input buttons 1415 through 1455 are provided for purposes of enabling the user to save and load target profiles. Button 1415 permits the user to close the screen. When this button is clicked, the current group of profiles will take effect. Cancel button 1425 is used to ignore current profile changes and revert back to the original profiles and close the screen. Read Trace button 1435 is used to load an existing and saved target profile from memory. The profiles can be stored in memory contained in one or more of the operator interface 21, in random access or permanent memory contained in the controller. Save trace button 1440 is provided for purposes of enabling a user to save the current profile. Read group button 1445 is provided for purposes of enabling a user to load an existing profile or set of profiles. Save group button 1450 is provided for purposes of enabling a user to save the current group of target profiles for a group of nozzle valve pins. The process tuning button 1455 is provided for purposes of enabling a user to change the settings (for example, the gains) for a particular nozzle valve in a control zone. Also displayed is a pressure range 1465 for the injection molding application.

In a preferred embodiment, the controller (16) includes instructions that instruct the actuator piston 40p, FIG. 6E, to first drive the valve pin (1041) upstream beginning from the gate closed position at high velocity to the first position at pressure 1311 (sensed drive fluid pressure or injection fluid pressure correlated to drive fluid pressure), FIG. 9, where the top end surface 40e′ of the piston 40p, FIG. 6E, is disposed close to the undersurface 20uws of the housing 20h, such as for example a selected axial distance X of between about 0.1 and about 2 mm, at which first position the distal end 1155 of the pin 1041 does not significantly restrict flow of injection fluid 100a, 100b through the gate and the pressure of the injection fluid is at maximum or close to maximum of about 15,000 psi as shown in FIG. 9. The X axis pressure scale shown in FIG. 9 can be recorded and displayed in the interface display shown in FIG. 9 either as the pressure of the drive fluid DF that is sensed by sensors 603ec or 603e or as a pressure correlated from the drive fluid pressure to the pressure of the injection fluid 100a, 100b. Thus, use of the sensors 603ec, 603e to measure pressure of the drive fluid DF can obviate the need for use of separate sensors that sense the pressure of the injection fluid 100a, 100b directly within the injection fluid flow channels 42, 44, 46 or within the cavity 30.

One example of the use of such a pressure detection system is where at the start of the injection cycle when the piston 40p is disposed in the fully downstream gate closed position 40gc, FIG. 6E, the restriction valve 600 is fully opened for approximately 0.5 seconds such that the piston 40p moves to the upstream (first) position shown in FIG. 6E where the top surface 40e is moved to a position 40e′ that is spaced the selected distance X from the undersurface 20uws. The precise position of the piston 40p at the selected axially spaced distance X can be monitored and detected by a position sensor as described above, or as described in U.S. Pat. No. 9,144,929, the disclosure of which is incorporated by reference in its entirety herein. When the position of the piston 40p has reached the first selected axially spaced position, namely the 40e′ from 20uws by X mm position, the restrictor valve 600 is closed, the drive fluid DF in upper chamber 30 is static, and the piston 40p is held stationary while the pressure of the drive fluid DF is monitored by sensor 603ec or 603e. The piston 40p is held stationary for the first period of time, a first portion of the duration of the injection cycle, until the sensor 603ec or 603e senses a preselected target pressure in the drive fluid DF (shown for example purposes in FIG. 9 occurring at about 4 seconds from start). Upon detection of the preselected target pressure, the controller 16 is programmed to trigger the restriction valve 600 to open piston and enable the piston 40p to be driven to a second or third axial position, such as a downstream position at which the end 1155 of the valve pin 1041 partially obstructs the gate and restricts flow of injection fluid 100a, 100b through the gate such that the pressure 1312 of the injection fluid against the tip end 1142 of the pin 1041 is reduced relative to a gate open position pressure 1311 and thus the recorded pressure 1312 in the drive fluid DF by sensor 603ec, 603e is reduced (for purposes of example in FIG. 9 the sensed reduced pressure at the second position is 7500 psi. Once the piston 40p is driven to the second or third position, the restrictor valve 600 is again closed and the piston 40p and valve pin 1041 remain relatively stationary for a second or third selected period of time. As shown in FIG. 9, the piston 40p (and associated valve pin 1041) is held and maintained in the first position (namely the axially spaced by X position) at an effective injection fluid pressure of 15,000 for about 3 seconds, FIG. 9, three (3) seconds being the first portion of the injection cycle. As shown in FIG. 9, the piston 40p (and associated valve pin 1041) is held and maintained in the second position, namely the position where the fluid pressure 1312 is reduced to about 7500 psi, for about twelve (12) seconds.

In the example just described, the first position (1311 pressure of 15,000 psi) could be a “fill” cavity position or a pre-fill position and the second position (at 1312 pressure of 7500 psi) could be a “pack” position.

As can be readily imagined the first portion of the duration of the injection cycle can be defined or determined by the amount of time that elapses between the time that the piston 40p first moves to the first axially spaced X position and the time that the pressure sensor 603ec, 603e detects the target pressure, opens the valve 600 and drives the piston to the second or third position. Alternatively the first portion of the duration of the injection cycle during with the piston 40p resides in the first position can be preselected by the user. In either case, the piston 40p is held in the first position for some period of time or portion of the injection cycle with the restriction valve 600 closed and with the sensor(s) 603ec, 603e acting to sense, detect pressure of the drive fluid and send a signal indicative of sensed pressure to the controller 16. The same is true with respect to the subsequent second or third positions and the subsequent second or third periods of time or portions of the duration of the injection cycle.

While specific embodiments of the present invention have been shown and described, it will be apparent that many modifications can be made thereto without departing from the scope of the invention. For example, in one embodiment the controller can be mounted on a hydraulic power unit.

Thus as described, the control data can comprise a profile of values of a condition of the injected polymer material or a condition or position of a selected component of the injection molding apparatus that is specified to occur at each point in time over the course or duration of an injection cycle when a part is produced in the mold cavity. Thus a profile defines a set of conditions, events or positions to which the injection material or the component of the apparatus is adjusted to attain over the course of a particular injection cycle. Typical injection material conditions that can be specified and controlled are pressure of the injection material at selected positions within a flow channel of the manifold, within an injection nozzle or within the mold cavity. Typical conditions or positions of components of the apparatus that can be controlled and comprise a profile are the position of the valve pin, the position of the screw of the barrel of the injection molding machine and position of an actuator piston. Such profiles are disclosed in detail in for example U.S. Pat. No. 6,464,909 and U.S. Pat. No. 8,016,581 and U.S. Pat. No. 7,597,828, the disclosures of which are incorporated by reference as if fully set forth herein.

1. In an apparatus for controlling flow of fluid injection material from an injection molding machine to a mold cavity, wherein the apparatus comprises: a manifold receiving the injected fluid mold material, the manifold having one or more fluid delivery channels that delivers the injected fluid material through a gate to the mold cavity;
a pressure sensing assembly comprising:
an actuator comprising a piston interconnected to a valve pin drivable along a drive path that extends between a gate closed position where a distal end of the valve pin stops flow through the gate and an upstream open position where the distal end of the valve pin is withdrawn upstream to enable injection fluid material to flow through the gate,
the piston being housed within a piston housing in an arrangement that forms an upstream drive chamber and a downstream drive chamber, the upstream drive chamber having a drive fluid port fluid sealably interconnected via an upstream drive fluid channel to a restriction valve, the piston being drivable upstream and downstream by drive fluid (14) pumped into and out of the upstream drive chamber through the drive fluid port, drive fluid channel and restriction valve,
a pressure sensor adapted to sense pressure of the drive fluid disposed within the upstream drive chamber or within the upstream drive fluid channel,
a controller that includes a program that instructs the restriction valve to close for a first portion of an injection cycle to prevent flow of the drive fluid such that the piston is held or stopped in a first position where drive fluid resides and remains within the upstream drive chamber or within the upstream drive fluid channel without flow through the restriction valve during the first portion of the injection cycle,
the pressure sensor sensing pressure of the drive fluid resident and remaining within either the upstream drive chamber or the upstream drive fluid channel during the first portion of the injection cycle,
the pressure sensor sending and the controller receiving a signal indicative of the sensed pressure, wherein the controller operates to execute a display of a visually recognizable format corresponding to the sensed pressure or uses the received signal in an algorithm to control movement of the piston.

2. The pressure sensor assembly according to claim 1 wherein the controller includes instructions that operate to display a visually recognizable format of the sensed pressure as either sensed pressure of the drive fluid or pressure of the injection fluid that correlates to the sensed pressure of the drive fluid.

3. The pressure sensor assembly according to claim 1 wherein the controller includes instructions that instruct the piston to travel to a selected maximum upstream position during the course of the injection cycle that leaves a space or volume within which drive fluid resides during the first portion of the injection cycle.

4. The pressure sensor assembly according to claim 3 wherein the selected maximum upstream position of the piston is selected such that an upstream end surface of the piston is spaced an axial distance of between 0.1 and 2.0 mm from an opposing undersurface of an upstream wall of the upstream drive chamber.

5. The pressure sensor assembly according to claim 3 wherein the selected maximum upstream position of the piston is selected such that an upstream end surface of the piston is spaced an axial distance of between 0.25 and 1.0 mm from an opposing undersurface of an upstream wall of the upstream drive chamber.

6. The pressure sensor assembly according to claim 1 wherein an upstream surface of the piston is spaced a selected axial distance of 0.1 mm or greater away from an undersurface of the housing or upstream drive chamber during the entire course of the injection cycle.

7. The pressure sensor assembly according to claim 1 further including a source of drive fluid that is drivable into and out of the upper drive chamber through the restriction valve and upstream drive fluid channel, the restriction valve being controllably openable by the controller to a selected degree to enable flow of drive fluid into and out of the upstream drive chamber at a selectable rate of flow to control rate of travel of the piston, the restriction valve being controllably closable to controllably stop flow of drive fluid into and out of the upstream drive chamber and to stop movement of the piston.

8. The pressure sensor assembly according to claim 1 wherein the controller includes instructions that instruct the piston to travel, subsequent to the first portion of the injection cycle, to a second position for a second portion of the injection cycle where a distal end of the valve pin is positioned relative to the gate such that rate of flow of injection fluid is selectively controlled.

9. The pressure sensor assembly according to claim 8 wherein the instructions of the controller operate to drive the piston to the second position in response to receipt of a first trigger signal from the pressure sensor corresponding to a first selected target pressure.

10. The pressure sensor assembly according to claim 8 wherein the controller includes instructions that instruct the piston to travel, subsequent to the second portion of the injection cycle, to a third position for a third portion of the injection cycle where a distal end of the valve pin is positioned relative to the gate such that rate of flow of injection fluid is selectively controlled.

11. The pressure sensor assembly according to claim 10 wherein the instructions of the controller operate to drive the piston to the third position in response to receipt of a second trigger signal from the pressure sensor corresponding to a second selected target pressure.

12. The pressure sensor assembly according to claim 8 wherein the first position is a position where a distal end of the valve pin is positioned relative to the gate such that flow of injection fluid is not significantly restricted and injection fluid flows at a maximum speed or a relatively high speed or velocity or pressure at and through the gate and wherein the second position is a position wherein the distal end of the valve pin is disposed axially intermediate a gate closed and a fully gate open position such that the end of the valve pin restricts or reduces rate or velocity of flow or pressure of the injection fluid flowing through or exerted at the gate to a selected reduced velocity or pressure that is less than a maximum rate of flow or pressure.

13. The pressure sensor assembly according to claim 8 wherein the second position is a position where a distal end of the valve pin is positioned relative to the gate such that flow of injection fluid is (a) not significantly restricted and injection fluid flows at a relatively high speed or velocity or pressure at and through the gate or (b) such that the distal end of the valve pin is disposed axially intermediate a gate closed and a fully gate open position such that the end of the valve pin restricts or reduces rate or velocity of flow or pressure of the injection fluid flowing through or exerted at the gate to a selected reduced velocity or pressure that is less than a maximum velocity or pressure.

14. The pressure sensor assembly according to claim 1 wherein the controller includes instructions that instruct the actuator to drive the valve pin upstream beginning from the gate closed position to the first position for the first portion of the injection cycle and subsequently to one or more different subsequent positions for one or more different subsequent portions of the injection cycle in response to receipt by the controller of one or more trigger signals from the pressure sensor corresponding to one or more selected sensed target pressures.

15. A method of measuring pressure of an injection fluid material injected into an apparatus for controlling rate of flow of the injection fluid material from an injection molding machine to a mold cavity, wherein the apparatus comprises: a manifold receiving the injected fluid material, the manifold having one or more fluid delivery channels that delivers the injected fluid material through a gate to the mold cavity, an actuator comprising a piston interconnected to a valve pin drivable along a drive path that extends between a gate closed position where a distal end of the valve pin obstructs the gate and an upstream open position where the distal end of the valve pin is withdrawn upstream to enable injection fluid material to flow through the gate, wherein the piston is housed within a piston housing in an arrangement that forms an upstream drive chamber and a downstream drive chamber, the upstream drive chamber having a drive fluid port fluid sealably interconnected via an upstream drive fluid channel to a restriction valve, the piston being drivable upstream and downstream by drive fluid pumped into and out of the upstream drive chamber through the drive fluid port, drive fluid channel and restriction valve,
the method being characterized in that:
a pressure sensor is adapted to sense pressure of the drive fluid disposed within the upstream drive chamber or within the upstream drive fluid channel,
closing the restriction valve for a first portion of an injection cycle to prevent flow of the drive fluid such that the piston is held or stopped in a first fully or partially open position where drive fluid resides and remains within the upstream drive chamber or within the upstream drive fluid channel without flow through the restriction valve during the first portion of the injection cycle,
sensing pressure of the drive fluid resident and remaining within either the upstream drive chamber or the upstream drive fluid channel via the pressure sensor during the first portion of the injection cycle,
displaying the sensed pressure of the drive fluid on a display in a visually recognizable format corresponding to the sensed pressure or, using the sensed pressure as a variable in an algorithm to control movement of the piston.

16. A method of measuring pressure of an injection fluid material comprising operating a pressure sensing assembly according to claim 1.

17. An apparatus for controlling the rate of flow of fluid injection material from an injection molding machine to a mold cavity, the apparatus comprising:
a manifold receiving the injected fluid mold material, the manifold having one or more fluid delivery channels that delivers the injected fluid material through a gate to the mold cavity;
an actuator comprising a piston interconnected to a valve pin drivable along a drive path that extends between a gate closed position where a distal end of the valve pin obstructs the gate and an upstream open position where the distal end of the valve pin is withdrawn upstream to enable injection fluid material to flow through the gate,
the piston being housed within a piston housing in an arrangement that forms an upstream drive chamber and a downstream drive chamber, the upstream drive chamber having a drive fluid port fluid sealably interconnected via an upstream drive fluid channel to a restriction valve, the piston being drivable upstream and downstream by drive fluid pumped into and out of the upstream drive chamber through the drive fluid port, drive fluid channel and restriction valve,
a pressure sensor adapted to sense pressure of the drive fluid disposed within the upstream drive chamber or within the upstream drive fluid channel,
a controller that includes a program that instructs the restriction valve to close for a first portion of an injection cycle to prevent flow of the drive fluid such that the piston is held or stopped in a first fully or partially open position where drive fluid resides and remains within the upstream drive chamber or within the upstream drive fluid channel without flow through the restriction valve during the first portion of the injection cycle,
the pressure sensor sensing pressure of the drive fluid resident and remaining within either the upstream drive chamber or the upstream drive fluid channel during the first portion of the injection cycle.

18. An apparatus according to claim 17 wherein the pressure sensor sends and the controller receives a signal indicative of the sensed pressure, the controller including instructions that operate to execute a display of a visually recognizable format corresponding to the sensed pressure or uses the received signal in an algorithm to control movement of the piston.

19. An apparatus according to claim 17 wherein the controller includes instructions that instruct the piston to travel to a selected maximum upstream position during the course of the injection cycle that leaves a space or volume within which drive fluid resides during the first portion of the injection cycle.

20. An apparatus according to claim 19 wherein the maximum upstream position of the piston is selected such that an upstream end surface of the piston is spaced an axial distance of between 0.1 and 2.0 mm from an opposing undersurface of an upstream wall of the upstream drive chamber.

21. An apparatus according to claim 19 wherein the maximum upstream position of the piston is selected such that an upstream end surface of the piston is spaced an axial distance of between 0.25 and 1.0 mm from an opposing undersurface of an upstream wall of the upstream drive chamber.

22. An apparatus according to claim 17 wherein an upstream surface of the piston remains spaced at least a selected axial distance greater than 0.1 mm away from an undersurface of the housing or upstream drive chamber during the entire course of the injection cycle.

23. An apparatus according to claim 17 further including a source of drive fluid that is drivable into and out of the upper drive chamber through the restriction valve and upstream drive fluid channel, the restriction valve being controllably openable by the controller to a selected degree to enable flow of drive fluid into and out of the upstream drive chamber at a selectable rate of flow to control rate of travel of the piston, the restriction valve being controllably closable to controllably stop flow of drive fluid into and out of the upstream drive chamber and to stop movement of the piston.

24. An apparatus according to claim 17 wherein the controller includes instructions that instruct the piston to travel, subsequent to the first portion of the injection cycle, to a second position for a second portion of the injection cycle where a distal end of the valve pin is positioned relative to the gate such that rate of flow of injection fluid is selectively controlled.

25. An apparatus according to claim 17 wherein the instructions of the controller operate to drive the piston to the second position in response to receipt of a first trigger signal from the pressure sensor that corresponds to a first selected target pressure.

26. An apparatus according to claim 17 wherein the controller includes instructions that instruct the piston to travel, subsequent to the second portion of the injection cycle, to a third position for a third portion of the injection cycle where a distal end of the valve pin is positioned relative to the gate such that rate of flow of injection fluid is selectively controlled.

27. An apparatus according to claim 17 wherein the instructions of the controller operate to drive the piston to the third position in response to receipt of a second trigger signal from the pressure sensor that corresponds to a second selected target pressure.

28. An apparatus according to claim 24 wherein the first position is a position where a distal end of the valve pin is positioned relative to the gate such that flow of injection fluid is not significantly restricted and injection fluid flows at a maximum speed or a relatively high speed or velocity or pressure at and through the gate and wherein the second position is a position wherein the distal end of the valve pin is disposed axially intermediate a gate closed and a fully gate open position such that the end of the valve pin restricts or reduces rate or velocity of flow or pressure of the injection fluid flowing through or exerted at the gate to a selected reduced velocity or pressure that is less than a maximum rate of flow or pressure.

29. The pressure sensor assembly according to claim 24 wherein the second position is a position where a distal end of the valve pin is positioned relative to the gate such that (a) flow of injection fluid is not significantly restricted and injection fluid flows at a relatively high speed or velocity or pressure at and through the gate or (b) such that the distal end of the valve pin is disposed axially intermediate a gate closed and a fully gate open position such that the end of the valve pin restricts or reduces rate or velocity of flow or pressure of the injection fluid flowing through or exerted at the gate to a selected reduced velocity or pressure that is less than a maximum velocity or pressure.

30. The pressure sensor assembly according to claim 17 wherein the controller includes instructions that instruct the actuator to drive the valve pin upstream beginning from the gate closed position to the first position for the first portion of the injection cycle and subsequently to one or more different subsequent positions for one or more different subsequent portions of the injection cycle in response to receipt by the controller of one or more trigger signals from the pressure sensor corresponding to one or more selected sensed target pressures.

31. A method of measuring pressure of an injection fluid material comprising operating an apparatus according to claim 17.
